(19) United States
(12) Patent Application Publication
(10) Pub. No.: US 2026/0230146 A1
(43) Pub. Date: Aug. 6, 2026

(54) CHANNEL STATE INFORMATION TRANSMISSION METHOD AND APPARATUS, TERMINAL, AND NETWORK SIDE DEVICE

(71) Applicant: VIVO MOBILE COMMUNICATION CO., LTD., Guangdong (CN)

(72) Inventors: Lu JIANG, Guangdong (CN); Gen LI, Guangdong (CN); Xiaohang CHEN, Guangdong (CN)

(73) Assignee: VIVO MOBILE COMMUNICATION CO., LTD., Guangdong (CN)

(21) Appl. No.: 19/631,855

(22) Filed: Mar. 27, 2026

Related U.S. Application Data
(63) Continuation of application No. PCT/CN2024/120910, filed on Sep. 25, 2024.

(30) Foreign Application Priority Data
Sep. 28, 2023 (CN) 202311284447.1

(51) Int. Cl. H04B 7/06

(52) U.S. Cl. CPC H04B 7/0626; H04B 7/0639

(57) ABSTRACT

A channel state information transmission method and apparatus, a terminal, and a network side device. The method includes: receiving, by a terminal, a channel state information (CSI) report configuration; and reporting, by the terminal, a CSI report based on the CSI report configuration, where resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration.

### CROSS-REFERENCE TO RELATED APPLICATIONS

This application is a continuation of PCT Application No. PCT/CN2024/120910 filed on Sep. 25, 2024, which claims priority to Chinese Patent Application No. 202311284447.1, filed on Sep. 28, 2023, which are incorporated herein by reference in their entireties.

### TECHNICAL FIELD

This application belongs to the field of communication technologies, and in particular, to a channel state information transmission method and apparatus, a terminal, and a network side device.

### BACKGROUND

At present, for network energy saving, one channel state information (CSI) report configuration (namely, CSI report config) may include one or more sub-configurations (sub-config), each sub-config corresponds to a configuration of one spatial domain pattern (SD pattern), and a terminal supports reporting CSI of one or more sub-configs in one CSI report config. However, to measure channels of two transmission reception points (TRP), multiple non-zero power (NZP) channel state information reference signal (CSI-RS) resources (namely, NZP CSI-RS resource) included in one CSI resource set may be configured into two resource groups, to distinguish which TRP does a CSI-RS resource come from. A network side device may further configure at least one CSI-RS resource pair, where two CSI-RS resources in the resource pair come from two resource groups respectively, and based on the foregoing configuration, the terminal may not only calculate NCJT CSI when two CSI-RS resources included in each CSI-RS resource pair are assumed to be transmitted in a non-coherent joint transmission (NCJT) mode, but also calculate s-TRP CSI when a CSI-RS resource in the two resource groups is assumed to be transmitted in a single TRP (s-TRP) mode.

However, in the prior art, there is no corresponding solution to how to control CSI report when the terminal supports both CSI report of at least one sub-config in one CSI report config and CSI report of multi-TRPs.

### SUMMARY

Embodiments of this application provide a channel state information transmission method and apparatus, a terminal, and a network side device.

According to a first aspect, a channel state information transmission method is provided, and the method includes:
receiving, by a terminal, a channel state information (CSI) report configuration; and
reporting, by the terminal, a CSI report based on the CSI report configuration, where
resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

According to a second aspect, a channel state information transmission apparatus is provided, and the apparatus includes:
a first receiving module, configured to receive a channel state information (CSI) report configuration; and
a reporting module, configured to report a CSI report based on the CSI report configuration, where
resources associated with the CSI report configuration are configured as N resource groups, the CSI report configuration is associated with at least one sub-configuration, and the CSI report includes CSI of the at least one sub-configuration; or a terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

According to a third aspect, a channel state information transmission method is provided, and the method includes:
sending, by a network side device, a channel state information (CSI) report configuration; and
receiving, by the network side device, a CSI report, where
resources associated with the CSI report configuration are configured as N resource groups, the CSI report configuration is associated with at least one sub-configuration, and the CSI report includes CSI of the at least one sub-configuration; or the network side device prohibits configuring the CSI report configuration to be associated with at least one sub-configuration when resources associated with the CSI report configuration are configured as N resource groups; or the network side device prohibits configuring resources associated with the CSI report configuration as N resource groups when the CSI report configuration is associated with at least one sub-configuration; and N is an integer greater than or equal to 2.

According to a fourth aspect, a channel state information transmission apparatus is provided, and the apparatus includes:
a sending module, configured to send a channel state information (CSI) report configuration; and
a second receiving module, configured to receive a CSI report, where
resources associated with the CSI report configuration are configured as at least two resource groups, the CSI report configuration is associated with at least one sub-configuration, and the CSI report includes CSI of the at least one sub-configuration; or a network side device prohibits configuring the CSI report configuration to be associated with at least one sub-configuration when resources associated with the CSI report configuration are configured as at least two resource groups; or the network side device prohibits configuring resources associated with the CSI report configuration as at least two resource groups when the CSI report configuration is associated with at least one sub-configuration.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface, where the communication interface is configured to: receive a channel state information (CSI) report configuration; and report a CSI report based on the CSI report configuration, where resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

According to a seventh aspect, a network side device is provided. The network side device includes a processor and a memory, the memory stores a program or an instruction that can be run on the processor, and the program or the instruction is executed by the processor to implement the steps of the method according to the third aspect.

According to an eighth aspect, a network side device is provided, including a processor and a communication interface, where the communication interface is configured to send a channel state information (CSI) report configuration; and the communication interface is further configured to receive a CSI report, where resources associated with the CSI report configuration are configured as N resource groups, the CSI report configuration is associated with at least one sub-configuration, and the CSI report includes CSI of the at least one sub-configuration; or the network side device prohibits configuring the CSI report configuration to be associated with at least one sub-configuration when resources associated with the CSI report configuration are configured as N resource groups; or the network side device prohibits configuring resources associated with the CSI report configuration as N resource groups when the CSI report configuration is associated with at least one sub-configuration; and N is an integer greater than or equal to 2.

According to a ninth aspect, a channel state information transmission system is provided, including a terminal and a network side device. The terminal may be configured to perform the steps of the channel state information transmission method according to the first aspect, and the network side device may be configured to perform the steps of the channel state information transmission method according to the third aspect.

According to a tenth aspect, a readable storage medium is provided. The readable storage medium stores a program or an instruction, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction, to implement the steps of the method according to the first aspect or the steps of the method according to the third aspect.

According to a twelfth aspect, a computer program/program product is provided. The computer program/program product is stored in a storage medium, and the computer program/program product is executed by at least one processor to implement the steps of the method according to the first aspect or the steps of the method according to the third aspect.

### BRIEF DESCRIPTION OF DRAWINGS

FIG. 1 is a block diagram of a wireless communication system to which embodiments of this application are applicable;

FIG. 2a is a first schematic diagram of multi-TRP transmission according to an embodiment of this application;

FIG. 2b is a second schematic diagram of multi-TRP transmission according to an embodiment of this application;

FIG. 2c is a third schematic diagram of multi-TRP transmission according to an embodiment of this application;

FIG. 3 is a schematic diagram of a CMR pair of a CSI report configuration according to an embodiment of this application;

FIG. 4 is a schematic diagram of a CMR pair formed by resources of two resource groups according to an embodiment of this application;

FIG. 5 is a flowchart of a channel state information transmission method according to an embodiment of this application;

FIG. 6 is a flowchart of another channel state information transmission method according to an embodiment of this application;

FIG. 7 is a structural diagram of a channel state information transmission apparatus according to an embodiment of this application;

FIG. 8 is a structural diagram of another channel state information transmission apparatus according to an embodiment of this application;

FIG. 9 is a structural diagram of a communication device according to an embodiment of this application;

FIG. 10 is a structural diagram of a terminal according to an embodiment of this application; and

FIG. 11 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

The term “indication” in this application may be either a direct indication (or referred to as an explicit indication) or an indirect indication (or referred to as an implicit indication). The direct indication can be understood as that a sender clearly informs a receiver of specific information, an operation required to be performed, a request result, or the like in a sent indication; and the indirect indication can be understood as that the receiver determines corresponding information based on an indication sent by the sender, or makes a determination and determines the operation required to be performed, the request result, or the like based on a determination result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following descriptions describe a new radio (NR) system for example purposes, and NR terms are used in most of the following descriptions, but these technologies can also be applied to a system other than the NR system, for example, a 6^{th} generation (6G) communication system.

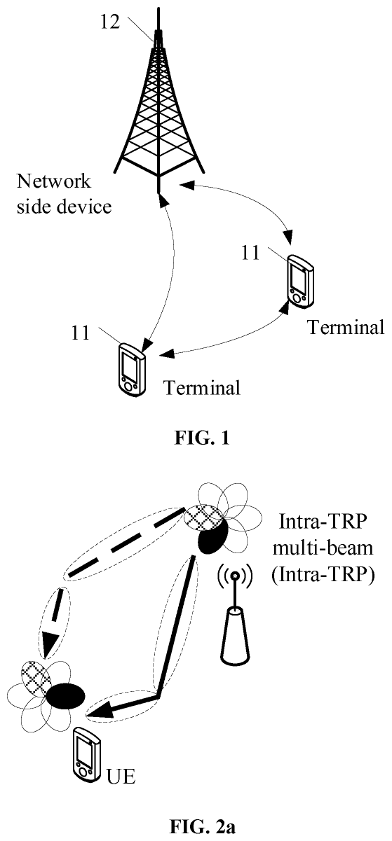

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, a flight vehicle, vehicle user equipment (VUE), ship-borne equipment, pedestrian user equipment (PUE), smart household (household devices with wireless communication functions, such as a refrigerator, a television, a washing machine, or furniture), a game console, a personal computer (PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. As long as a same technical effect is achieved, the base station is not limited to a specified technical term. It should be noted that, in the embodiments of this application, only a base station in an NR system is used as an example for description, but a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), centralized network configuration (CNC), a network repository function (NRF), a network exposure function (NEF), a local NEF (L-NEF), a binding support function (BSF), an application function (AF), and the like. It should be noted that, in the embodiments of this application, only a core network device in an NR system is used as an example for description, and a specific type of the core network device is not limited.

For ease of understanding, some content involved in the embodiments of this application is described below.

### 1. Network Energy Saving

The network energy saving is very important for environment sustainability, reducing environmental impact (greenhouse gas emission), and reducing operation costs. With the popularity of 5G in all walks of life and different geographic areas, to meet more advanced services and applications, such as very high data rate (for example, extended reality (XR)) services, network deployment has become more intensive, and more antennas, larger bandwidth, and more frequency bands are needed. The intensive deployment and large-scale use of these devices pose higher challenges to the energy consumption of a 5G network device.

Energy consumption has become an important part of operating expense (OPEX) of an operator. Based on a report of global system for mobile communications association (GSMA), energy costs of a mobile network accounts for about 23% of total costs of the operator. Most energy consumption comes from a radio access network, especially an active antenna unit (AAU), in which data center and optical fiber transmission account for a small proportion. Power consumption of radio access may be divided into two parts: a dynamic part, that is, energy consumption while data transmission/reception is in progress; and a static part, and even if data transmission/reception is not in progress, it needs constant energy consumption to maintain necessary operations of a radio access device. Therefore, the impact of 5G on the environment needs to be controlled, and a new solution needs to be developed to improve network energy saving effect.

### 2. Multi-TRPs

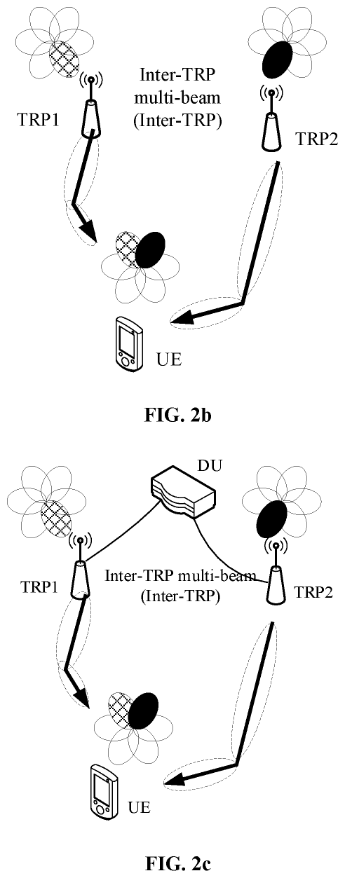

A scenario of multi-TRPs/multi-panel is proposed in 3rd generation partnership project (3GPP), and the multi-TRPs transmission may increase reliability and throughput performance of transmission. For example, UE may receive same data or different data from multiple TRPs. The multi-TRP transmission may include the following scenarios:
(1) intra TRP multi-antenna panel transmission, for example, as shown in FIG. 2a;
(2) inter TRP multi-TRPs/panel transmission and an ideal backhaul, for example, as shown in FIG. 2b; and
(3) inter TRP multi-TRPs/panel transmission and a non-ideal backhaul, for example, as shown in FIG. 2c.

The scenario of multi-TRPs/multi-panel is standardized in 3GPP Rel-16, and reliability and throughput performance of transmission may be increased. For example, UE may receive same data or different data from multiple TRPs. The inter TRP may be divided into the ideal backhaul and the non-ideal backhaul. In the non-ideal backhaul, there is a large delay in inter TRP mutual information, which is suitable for independent scheduling. Acknowledgement (ACK)/negative acknowledgement (NACK) and a channel state information (CSI) report are fed back to each TRP respectively. Generally, it is suitable for scheduling multiple downlink control information (DCI), that is, each TRP sends its own physical downlink control channel (PDCCH). Each PDCCH schedules its own physical downlink shared channel (PDSCH), and multiple control resource sets (CORESET) configured for UE are associated with different radio resource control (RRC) parameter control resource set pool indexes (CORESETPoolIndex), to be corresponding to different TRPs. Multiple PDSCHs scheduled by multiple DCIs may be non-overlapping, partially overlapping, and completely overlapping in time-frequency resources. On overlapping time-frequency resources, each TRP performs independent precoding based on its own channel, and the UE receives, in a non-coherent joint transmission (NCJT) mode, multi-layer data streams belonging to multiple PDSCHs.

In the ideal backhaul, scheduling information and feedback information of the UE can be exchanged between multiple TRPs in real time, and in addition to scheduling multiple PDSCHs by using the multiple DCIs, the PDSCH may also be scheduled with single DCI, which includes the following transmission schemes:
space division multiplexing (SDM): different data layers of a same transport block (TB) come from NCJT of different TRPs;
frequency division multiplexing (FDM): different frequency domain resources mapped by a same redundancy version (RV) of a same TB originate from different TRPs, or different RVs of a same TB are mapped to different frequency domain resources and originate from different TRPs; and
time-division multiplexing (TDM): multiple repetitions of different RVs of a same TB come from different TRPs, such as repetitions in one slot or repetitions in multiple slots.

In this case, the ACK/NACK feedback and the CSI report may be fed back to any TRP.

### 3. CSI Report Framework

A CSI report configuration (CSI-ReportConfig) mainly includes the following aspects:
CSI resource setting: at least one CSI resource for channel measurement needs to be configured;
report configuration type (reportConfigType): indicates a time domain behavior of CSI report;
report frequency domain configuration (reportFreqConfiguration): indicates a frequency domain behavior of CSI report, that is, wideband report or narrowband report;
report quantity (reportQuantity): indicates parameters included in the report, including: none, cri-RI-PMI-CQI, cri-RI-i1, cri-RI-i1-CQI, cri-RI-CQI, cri-RSRP, ssb-Index-RSRP, and cri-RI-LI-PMI-CQI;
code book configuration (codebookConfig): indicates a type of a reported code book, including two types: Type I and Type II; and
time restriction for channel measurements (timeRestrictionForChannelMeasurements): indicates whether to restrict a time domain occasion of CSI measurement.

### 4. Concept of Sub-Configuration (Sub-Config) CSI Report Sub-Configuration

One CSI-ReportConfig includes multiple sub-configs, and each sub-config corresponds to one spatial domain pattern (SD pattern).

An enhancement scheme is: when one CSI-ReportConfig is configured with L sub-configs, N sub-config CSI reports are activated through layer 1 (L1)/layer 2 (L2) signaling.

### 5. R18 Multi-CSI Enhancement

In an R18 network energy saving project, UE is supported in reporting multiple sub-config CSI reports belonging to a same CSI report config. Specifically, it can be described as: a network side triggers the UE to report N sub-configuration CSI reports in the L configured sub-configurations belonging to a same csi-ReportConfig, periodic multi-CSI report takes effect once RRC is configured, and semi-static and aperiodic multi-CSI report is triggered by DCI and a media access control control element (MAC CE).

In the framework of R18, a sub-configuration of Type I shutdown includes a port subset indicator and the like, where an application scope of the port subset indicator is all resources in a resource set for channel measurement in a resource setting associated with csi-ReportConfig to which the sub-configuration belongs; and a sub-configuration of Type II shutdown includes one list of non-zero power (NZP) channel state information reference signal (CSI-RS) resources, and CSI corresponding to the sub-configuration is calculated based on the NZP CSI-RS resources included in the sub-configuration.

The following lists examples of sub-configurations, and sub-configurations that combine a spatial domain and a power domain.

```
Example 1: CSI-ReportSubConfiguration ::= SEQUENCE {
  CSI-ReportSubConfigId =1
  port-subsetIndicator
  RI restriction
  codebookSubsetRestriction
  powerControlOffset}
```

The sub-configuration Id=1, corresponding to an adaptation pattern of a spatial domain (SD) and a power domain (PD), including parameters used for CSI calculation of the sub-configuration in a case of spatial domain Type I shutdown and power domain adaptation, and for remaining required parameters, refer to csi-ReportConfig to which the sub-configuration belongs.

```
Example 2: CSI-ReportSubConfiguration ::= SEQUENCE {
  CSI-ReportSubConfigId =2
  NZP-CSI-RS-ResourceList
  powerControlOffset }
```

The sub-configuration Id=2, corresponding to an adaptation pattern of an SD and a PD, including parameters and CSI-RS resources used for CSI calculation of the sub-configuration in a case of spatial domain Type II shutdown and power domain adaptation.

### 6. Non-Coherent Joint Transmission (NCJT) CSI Report

Rel-17 enhances a CSI-RS configuration and CSI feedback of the multi-TRP. To measure channels of two TRPs, multiple non-zero power CSI-RS resources (NZP CSI-RS resource) included in one CSI resource set are divided into two resource groups, to distinguish which TRP does a CSI-RS resource come from. In addition, the network may further configure at least one CSI-RS resource pair, where two CSI-RS resources in the resource pair come from two resource groups respectively. Based on the foregoing configuration, the UE may calculate NCJT CSI when two CSI-RS resources included in each CSI-RS resource pair are assumed to be transmitted in an NCJT mode, and may further calculate single TRP (s-TRP) CSI when a CSI-RS resource in the two groups is assumed to be transmitted in an STRP mode. The network may configure two CSI feedback modes: the UE reports one NCJT CSI and X=0, 1, 2 STRP CSI, or reports best CSI in the NCJT CSI and the STRP CSI. An NCJT CSI feedback of Rel-17 is enhanced on the basis of Type I code book. Two precoding matrix indicators (PMI) and two rank indicators (RI) of the NCJT CSI feedback respectively correspond to two CSI-RS resources and one channel quality indicator (CQI) assumed by the NCJT. PMI of NCJT does not include amplitude-phase information between the two PMIs because two TRPs cannot be synchronized accurately, and transmitted signals cannot guarantee a fixed phase relationship.

R17 NCJT CSI report is to distinguish two TRPs with different resource groups in a same resource set, and one resource from each of the two resource groups may be matched into a channel measurement resource (CMR) pair (namely, CMR pair).

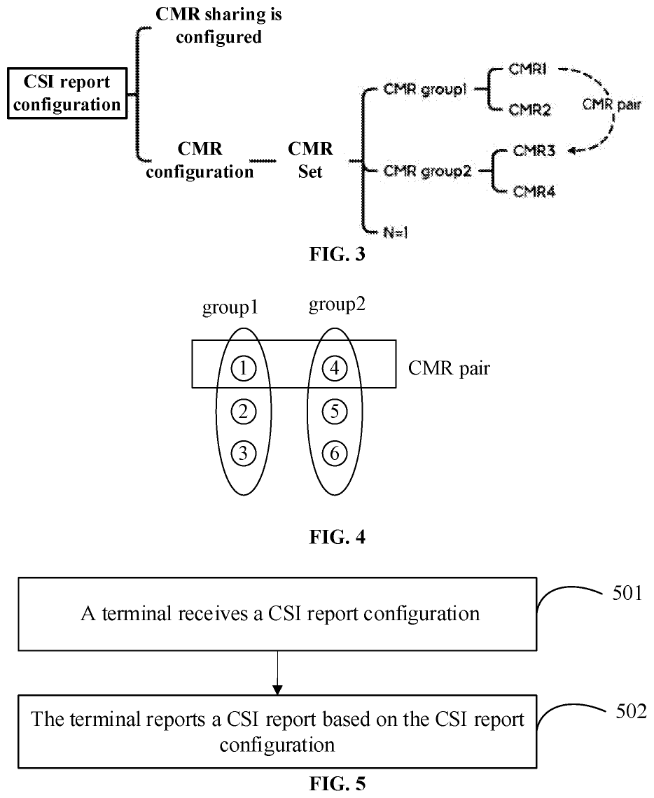

For example, as shown in FIG. 3, two CMR groups (namely, CMR group) belonging to a same CMR set (namely, CMR set) respectively represent two TRPs, where CMR1 and CMR3 represent one CMR pair used for calculating NCJT CSI.

One configuration is illustrated as follows: configure CMR pair in an information element (IE) NZP-CSI-RS-ResourceSet:

CMRGroupingAndPairing-r17 ::= SEQUENCE {
nrofResourcesGroup1-r17 INTEGER (1..7),
nrofResourcesGroup2-r17 INTEGER (1..7),
pair1OfNZP-CSI-RS-r17 NZP-CSI-RS-Pairing-r17 OPTIONAL, -- Need R
pair2OfNZP-CSI-RS-r17 NZP-CSI-RS-Pairing-r17 OPTIONAL -- Need R
}
NZP-CSI-RS-Pairing-r17 ::= SEQUENCE {
nzp-CSI-RS-ResourceId1-r17 NZP-CSI-RS-ResourceSetId,
nzp-CSI-RS-ResourceId2-r17 NZP-CSI-RS-ResourceSetId
}

A number of resources in resource group1 and a number of resources in resource group2 are configured. It is assumed that the number of resources in resource group1 is A, and the number of resources in resource group2 is B, first A resources configured in the resource setting associated with the CSI report setting belong to resource group1, and next B resources belong to resource group2.

Specifically, for resources that the NCJT CSI report refers to, refer to the following example. In this example, a resource set for channel measurement is configured through RRC and includes two resource groups, resource group1 includes resource1/2/3, and resource group2 includes resource4/5/6. The two resource groups correspond to two TRPs respectively, and the protocol specifies that at most two CMR pairs are configured. In this example, only one CMR pair is configured, that is, resource1 and resource4 are configured as one CMR pair, as shown in FIG. 4.

For NCJT CSI, if there is only one CMR pair, NCJT CSI does not need to report CSI reference signal resource indicator (Channel State Information Reference Signal Resource Indicator, CRI); and if there are two CMR pairs, a function of CRI in NCJT CSI is to distinguish one of the two CMR pairs, because final NCJT CSI can only be CSI aimed at a single CMR pair.

A function of a shared CMR (sharedCMR) of RRC parameters is to inform UE whether a resource in the CMR pair can be used for calculating CSI of s-TRP. If sharedCMR is configured, the resource in the CMR pair can be used for calculating the CSI of s-TRP.

If ‘sharedCMR’ is not configured, then:
M1 is a number of resources other than the CMR pair in resource group1, and in this example, M1=2; and
M2 is a number of resources other than the CMR pair in resource group2, and in this example, M2=2.

If ‘sharedCMR’ is configured, that is, a resource in the resource pair can also be used for calculating NCJT CSI, then:
M1=K1 (the number of resources in resource group1)=3, M2=K2 (the number of resources in resource group2)=3, and
for s-TRP CSI, respective CRI is selected in a resource group of a respective TRP;
in the NCJT CSI report, SharedCMR, csi-ReportMode, and a number of pieces of single TRP CSI reported when the CSI report mode is the first mode (numberOfSingleTRP-CSI-Mode1) are all configured in csi-ReportConfig, where:
sharedCMR is used for CMR pair configuration and for calculating NCJT CSI; and
csi-ReportMode is used for configuring the CSI reporting mode, and mode 1 refers to reporting NCJT CSI and X pieces of s-TRP CSI, where X=value of numberOfSingleTRP-CSI-Mode1; and mode2 refers to best CSI in reported NCJT CSI and s-TRP CSI.

The following describes in detail the channel state information transmission method provided in the embodiments of this application through some embodiments and application scenarios thereof with reference to the accompanying drawings.

Referring to FIG. 5, FIG. 5 is a flowchart of a channel state information transmission method according to an embodiment of this application. The method may be performed by a terminal. As shown in FIG. 5, the method includes the following steps.

Step 501: A terminal receives a CSI report configuration.

Step 502: The terminal reports a CSI report based on the CSI report configuration.

Resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

For example, the CSI report configuration (CSI-ReportConfig) may include but is not limited to at least one of the following: a CSI resource setting, a report configuration type (reportConfigType), a report frequency domain configuration (reportFreqConfiguration), a report quantity (reportQuantity), a code book configuration (codebookConfig), a time restriction for channel measurements (timeRestrictionForChannelMeasurements), and the like. The sub-configuration may include but is not limited to at least one of the following: a port subset indicator, an RI restriction, a code book subset restriction (CBSR), a power offset value, at least one list of NZP CSI-RS resources (NZP-CSI-RS-ResourceList), and the like. It should be noted that the sub-configuration of this embodiment may also be represented as sub-configuration, sub-config, csi-ReportSubconfig, or the like.

In an implementation, the resources associated with the CSI report configuration are configured as N resource groups, and the CSI report configuration is associated with at least one sub-configuration (sub-config). In this case, the CSI report may include the CSI of the at least one sub-configuration. It should be noted that the N resource groups correspond to N TRPs, and CSI of each sub-configuration may include at least one of multi-TRP (namely, M-TRP) CSI and single TRP (namely, s-TRP) CSI. It should be further noted that when the CSI report configuration is associated with at least two sub-configurations, the CSI may include CSI of at least one sub-configuration in the at least two sub-configurations. For example, the multi-TRP may be NCJT CSI.

In another implementation, the terminal does not expect that the CSI report configuration is associated with at least one sub-configuration when the resources associated with the CSI report configuration are configured as N resource groups, or the terminal does not expect that the resources associated with the CSI report configuration are configured as N resource groups when the CSI report configuration is associated with at least one sub-configuration, that is, a network side device is not allowed to simultaneously configure the resources associated with the CSI report configuration to be configured as N resource groups and the CSI report configuration to be associated with at least one sub-configuration. Specifically, when the resources associated with the CSI report configuration are configured as N resource groups, the CSI report may include at least one of M-TRP CSI and s-TRP CSI; and when the CSI report configuration is associated with at least one sub-configuration, the CSI report may include CSI of at least one sub-configuration.

According to the channel state information transmission method provided in this embodiment of this application, the terminal receives a CSI report configuration, and reports a CSI report based on the CSI report configuration, where resources associated with the CSI report configuration are configured as N resource groups, the CSI report configuration is associated with at least one sub-configuration, and the CSI report includes CSI of the at least one sub-configuration. That is, in this embodiment of this application, the terminal may be configured to report multi-TRP CSI and single TRP CSI in one sub-config when the terminal supports both CSI report of at least one sub-config in one CSI report config and CSI report of multi-TRP, which is beneficial to assisting the network side device to make a shutdown decision of a spatial domain-related device (such as an antenna panel or a TRP). Alternatively, in this embodiment of this application, when the terminal supports both CSI report of at least one sub-config in one CSI report config and CSI report of multi-TRP, it is not expected that the CSI report configuration is associated with at least one sub-configuration when the resources associated with the CSI report configuration are configured as N resource groups, or it is not expected that the resources associated with the CSI report configuration are configured as N resource groups when the CSI report configuration is associated with at least one sub-configuration, which is not only beneficial to reducing complexity of the CSI report configuration, but also beneficial to reducing complexity of CSI report at a terminal side.

Optionally, the sub-configuration includes at least one of the following:
a first identifier, indicating a resource group associated with the sub-configuration;
a second identifier, indicating a transmission reception point (TRP) associated with the sub-configuration;
a port subset indicator (namely, port-SubsetIndicator);
a code book subset restriction (CBSR);
a rank indicator (RI) restriction;
at least one list of channel state information reference signal (CSI-RS) resources;
a power offset value;
channel measurement resource (CMR) pair configuration information;
a CSI report mode; and
a number of pieces of single TRP CSI reported when the CSI report mode is a first mode.

In this embodiment, the first identifier is used for indicating a resource group associated with the sub-configuration or a resource scope in which the sub-configuration works. For example, if the first identifier indicates resource group1, a resource group associated with the sub-configuration is resource group1; and if the first identifier indicates resource group1 and resource group2, resource groups associated with the sub-configuration are resource group1 and resource group2.

The second identifier is used for indicating a TRP associated with the sub-configuration. For example, the second identifier may include but is not limited to at least one of the following: a TRP identifier (TRP ID), a control resource set pool index (namely, CoresetPoolIndex), a transmission configuration indication (TCI) state (namely, TCI state), and a TCI state group identifier (namely, TCI state group Id).

The at least one group of CSI-RS resources may be, for example, at least one list of NZP CSI-RS resources (namely, list of NZP CSI-RS resources). It should be noted that the at least one group of NZP CSI-RS resources may also be represented as at least one resource list (resourceList), at least one NZP-CSI-RS resource list (NZP-CSI-RS-ResourceList), at least one NZP CSI-RS Resource List, or the like.

The power offset value (namely, powerOffset) may also be referred to as a delta power control offset value (namely, deltapowerControlOffset).

The CMR pair (namely, CMR Pair) configuration information is used for configuring at least one CMR pair. For example, the CMR pair configuration information may include CMR pairing information (namely, CMR pairing). In some optional embodiments, the sub-configuration may further include a shared CMR (sharedCMR), to indicate whether a resource in the CMR pair can be used for calculating s-TRP CSI.

The CSI report mode (namely, csi-ReportMode) is used for configuring the CSI reporting mode. For example, mode1 refers to reporting NCJT CSI and X pieces of s-TRP CSI, where X is equal to a value of the number of pieces of single TRP CSI reported when the CSI report mode is the first mode (namely, numberOfSingleTRP-CSI-Mode1); and mode2 refers to reporting best CSI in NCJT CSI and s-TRP CSI.

In some optional embodiments, three parameters: the port subset indicator (namely, Port-subset Indicator), the CBSR, and the RI restriction, are related parameters of Type I shutdown; and the at least one group of CSI-RS resources are related parameters of Type II shutdown. In addition, the port subset indicator (namely, Port-subset Indicator), the CBSR, and the RI restriction may be configured for each TRP, that is, the sub-configuration includes N port subset indicators, N CBSRs, and N RI restrictions; or one group of CSI-RS resources may be configured for each TRP, that is, the sub-configuration includes N groups of CSI-RS resources.

Optionally, the first identifier includes a bitmap for indicating the resource group associated with the sub-configuration;
or
the first identifier includes a resource group identifier of the resource group associated with the sub-configuration.

In an implementation, the resource group associated with the sub-configuration may be indicated by using a bitmap. For example, ‘01’ represents that the sub-configuration is associated with a 1^{st} resource group associated with the CSI report configuration, ‘10’ represents that the sub-configuration is associated with a 2^{nd} resource group associated with the CSI report configuration, and ‘11’ represents that the sub-configuration is associated with two resource groups associated with the CSI report configuration.

In another implementation, a resource group identifier may be used for indicating a resource group associated with the sub-configuration. For example, if the first identifier includes an identifier of resource group1, a resource group associated with the sub-configuration is resource group1; and if the first identifier includes an identifier of resource group1 and an identifier of resource group2, resource groups associated with the sub-configuration are resource group1 and resource group2.

Optionally, the sub-configuration includes N groups of CSI-RS resources, each group of CSI-RS resources includes at least one CSI-RS resource of one of N resource groups associated with the CSI report configuration, and the N groups of CSI-RS resources correspond to the N resource groups respectively;
or
the sub-configuration includes one group of CSI-RS resources, and a number of resources of the group of CSI-RS resources is the same as a number of the resources associated with the CSI report configuration;
or
the sub-configuration includes one group of CSI-RS resources, and the group of CSI-RS resources includes at least one resource of each of the N resource groups.

In an implementation, each sub-configuration may include N groups of CSI-RS resources, the N groups of CSI-RS resources correspond to the N resource groups respectively, and each group of CSI-RS resources includes at least one CSI-RS resource of one of the N resource groups, that is, one group of CSI-RS resources is configured for each TRP, and the group of CSI-RS resources configured for each TRP includes at least one resource of the resource group associated with the TRP. For example, the resource groups associated with the CSI report configuration include group1 and group2, where when group1 includes resource1, resource2, resource3, and resource4, and group2 includes resource6, resource7, resource8, and resource9, a resource configured for a 1^{st} list of CSI-RS resources in the sub-configuration may be a subset of group1, and a resource configured for a 2^{nd} list of CSI-RS resources in the sub-configuration may be a subset of group2.

For another example, the resources associated with the CSI report configuration are configured as two resource groups, namely, group1 and group2, two NZP-CSI-RS-ResourceLists are configured in the sub-configuration to cover the two resource groups in the CSI report configuration respectively, and resources in these two NZP-CSI-RS-ResourceLists respectively include subsets of different resource groups in the CSI report configuration. For example, when group1 has three resources, and group2 has two resources, a number of resources in NZP-CSI-RS-ResourceList1 in the sub-configuration is less than or equal to 3, and resources in NZP-CSI-RS-ResourceList1 are a subset of resources in group1; and a number of resources in NZP-CSI-RS-ResourceList2 in the sub-configuration is less than or equal to 2, and resources in NZP-CSI-RS-ResourceList2 are a subset of resources in group2.

In another implementation, each sub-configuration may include one group of CSI-RS resources, a number of resources of the group of CSI-RS resources is the same as a number of resources associated with the CSI report configuration, and a number of resource groups in each sub-configuration may also be the same as a number of resource groups associated with the CSI report configuration. For example, when a number of resources associated with the CSI report configuration is 5, a number of resources included in one group of CSI-RS resources in the sub-configuration is also 5, and a number of resource groups in the sub-configuration is also equal to a number of resource groups associated with the CSI report configuration.

For another example, the resource groups associated with the CSI report configuration include group1 and group2, where group1 includes resource1, resource2, resource3, and resource4, and group2 includes resource6, resource7, resource8, and resource9. One group of CSI-RS resources included in the sub-configuration may include resource10, resource11, resource12, resource13, resource14, resource15, resource16, and resource17, where a number of resources of group1 in the sub-configuration is 4, and a number of resources of group2 in the sub-configuration is 4.

For another example, the resources associated with the CSI report configuration are configured as two resource groups, namely, group1 and group2. The sub-configuration includes one NZP-CSI-RS-ResourceList, and a number of resources of NZP-CSI-RS-ResourceList in the sub-configuration is equal to a number of resources associated with the CSI report configuration, for example, the number of resources associated with the CSI report configuration is 5, where when first three resources correspond to group1, and last two resources correspond to group2, NZP-CSI-RS-ResourceList in the sub-configuration is also configured with five resources, first three resources correspond to group1, and last two resources correspond to group2.

It should be noted that resources in one group of CSI-RS resources included in the sub-configuration may be the same as the resources associated with the CSI report configuration, or may be different from the resources associated with the CSI report configuration.

In some optional embodiments, an arrangement order of the resources in the group of CSI-RS resources may be the same as an arrangement order of the resources associated with the CSI report configuration, so that based on a number of resources in each resource group in the sub-configuration and the arrangement order of the resources associated with the CSI report configuration, a resource group to which a resource in the group of CSI-RS resources belongs may be quickly determined.

In still another implementation, each sub-configuration includes one group of CSI-RS resources, and the group of CSI-RS resources includes at least one resource of each of the N resource groups. For example, the resource groups associated with the CSI report configuration include group1 and group2, where group1 includes resource1, resource2, resource3, and resource4, and group2 includes resource6, resource7, resource8, and resource9. One group of CSI-RS resources included in the sub-configuration may include a subset of group1 and a subset of group2. For example, one group of CSI-RS resources included in the sub-configuration includes resource1, resource2, resource6, and resource8. Based on the CSI report configuration, the UE can determine that resource1 and resource2 correspond to group1, and resource6 and resource9 correspond to group2.

For another example, the resources associated with the CSI report configuration are configured as two resource groups, namely, group1 and group2, group1 includes resource1, resource2, and resource3, and group2 includes resource4 and resource5. The sub-configuration includes one NZP-CSI-RS-ResourceList, and a resource set of a resource setting of the CSI report configuration includes resources of NZP-CSI-RS-ResourceList of all sub-configurations. For example, a resource set associated with the resource setting of the CSI report configuration is a complete set of NZP-CSI-RS-ResourceList of all sub-configurations. In addition, resources in NZP-CSI-RS-ResourceList included in the sub-configuration are a subset of the resources associated with the CSI report configuration. For example, when NZP-CSI-RS-ResourceList is configured with resource1, resource2, and resource4, based on the CSI report configuration, the terminal can learn of that resource1 and resource2 of NZP-CSI-RS-ResourceList are resources belonging to group1, and resource4 of NZP-CSI-RS-ResourceList is a resource belonging to group2.

Optionally, the CMR pair configuration information includes CMR pairing information; or the CMR pair configuration information includes an identifier of a CMR pair; or the CMR pair configuration information includes a sequence number of a CMR pair in all CMR pairs configured in the CSI report configuration.

In an implementation, at least one CMR Pair may be configured by using CMR pairing information (CMR pairing). For example, when N is 2, at least one CMR pair may be configured by using the CMR pairing information such as non-zero power CSI RS pairing information (NZP-CSI-RS-Pairing). For example, at most two CMR pairs can be configured. R17 is used as an example, and an example of a configuration mode of the CMR pair may be as follows:

“CMRGroupingAndPairing-r17 ::= SEQUENCE {
nrofResourcesGroup1-r17 INTEGER (1..7),
nrofResourcesGroup2-r17 INTEGER (1..7),
pair1OfNZP-CSI-RS-r17 NZP-CSI-RS-Pairing-r17 OPTIONAL, -- Need R
pair2OfNZP-CSI-RS-r17 NZP-CSI-RS-Pairing-r17 OPTIONAL -- Need R
}
NZP-CSI-RS-Pairing-r17 ::= SEQUENCE {
nzp-CSI-RS-ResourceId1-r17 NZP-CSI-RS-ResourceSetId,
nzp-CSI-RS-ResourceId2-r17 NZP-CSI-RS-ResourceSetId”.

In another implementation, at least one CMR Pair may be indicated by using the identifier of the CMR pair; or at least one CMR Pair may be indicated by using the sequence number of the CMR pair in all CMR pairs configured in the CSI report configuration. For example, when all possible CMR pairs have been configured in the CSI report configuration, the Id of the CMR pair or the sequence number of the CMR pair in all CMR pairs configured in the CSI report configuration may be included in the sub-configuration. For example, X is used for indicating that the CMR pair used in the sub-configuration is an X^{th} CMR pair configured in the CSI report configuration or a CMR pair with an Id of X.

Optionally, when the sub-configuration includes the CMR pair configuration information, and the sub-configuration does not include the at least one group of CSI-RS resources, the CMR pair configured by the CMR pair configuration includes resources from different resource groups in the resources associated with the CSI report configuration associated with the sub-configuration;
or
when the sub-configuration includes the CMR pair configuration information, and the sub-configuration includes the N groups of CSI-RS resources, the CMR pair configured by the CMR pair configuration includes resources from two groups of CSI-RS resources in the N groups of CSI-RS resources;
or
when the sub-configuration includes the CMR pair configuration information, and the sub-configuration includes one group of CSI-RS resources, the CMR pair configured by the CMR pair configuration includes resources from different resource groups in the one group of CSI-RS resources.

In an implementation, when the sub-configuration includes the CMR pair configuration information, and the sub-configuration does not include the at least one group of CSI-RS resources, the CMR pair configured by the CMR pair configuration includes resources from different resource groups in the resources associated with the CSI report configuration associated with the sub-configuration. That is, the CMR pair configured by the CMR pair configuration includes resources of different resource groups associated with the CSI report configuration. For example, if the resource groups associated with the CSI report configuration include group1 and group2, one resource of each CMR pair configured by the CMR pair configuration comes from group1, that is, a resource of group1, and the other resource comes from group2, that is, a resource of group2.

In another implementation, when the sub-configuration includes the CMR pair configuration information, and the sub-configuration includes the N groups of CSI-RS resources, the CMR pair configured by the CMR pair configuration includes resources from two groups of CSI-RS resources in the N groups of CSI-RS resources. For example, if the sub-configuration includes a 1^{st} list of CSI-RS resources and a 2^{nd} list of CSI-RS resources, one resource of each CMR pair configured by the CMR pair configuration is a resource of the 1^{st} list of CSI-RS resources, and the other resource of each CMR pair configured by the CMR pair configuration is a resource of the 2^{nd} list of CSI-RS resources.

For another example, the resource groups associated with the CSI report configuration include group1 and group2, group1 includes resource1, resource2, and resource3, and group2 includes resource4 and resource5; and the sub-configuration includes two NZP-CSI-RS-ResourceLists covering the two resource groups in the CSI report configuration respectively, and resources in these two NZP-CSI-RS-ResourceLists respectively include subsets of different resource groups in the CSI report configuration. For example, when group1 has three resources, and group2 has two resources, a number of resources in NZP-CSI-RS-ResourceList1 in the sub-configuration is less than or equal to 3, and the resources are a subset of resources in group1; and a number of resources in NZP-CSI-RS-ResourceList2 included in the sub-configuration is less than or equal to 2, and the resources are a subset of resources in group2. If resource1 and resource4 associated with the CSI report configuration are one CMR pair, resource2 and resource15 are one CMR pair, NZP-CSI-RS-ResourceList1 of the sub-configuration includes resource1 and resource2, and NZP-CSI-RS-ResourceList2 of the sub-configuration includes resource4, the terminal may understand, based on the CSI report configuration, that resource1 and resource4 in the sub-configuration are one CMR pair. It should be noted that, in this example, resources in a resource setting in the CSI report configuration are a complete set of resources configured in all sub-configurations, and the CMR pair also needs to configure all possible CMR pairs in the CSI report configuration, which may exceed a current limit of R17 (only two CMR pairs can be configured at most), that is, configuring multiple lists of CMR pairs.

In still another implementation, when the sub-configuration includes the CMR pair configuration information, and the sub-configuration includes one group of CSI-RS resources, the CMR pair configured by the CMR pair configuration includes resources from different resource groups in the one group of CSI-RS resources. To be specific, a resource in each CMR pair configured by the CMR pair configuration is a resource of the group of CSI-RS resources, one resource of each CMR pair is a resource belonging to one resource group in the N resource groups in the group of CSI-RS resources, and the other resource of each CMR pair is a resource belonging to another resource group in the N resource groups in the group of CSI-RS resources. It should be noted that one group of CSI-RS resources included in the sub-configuration includes a resource of each of the N resource groups.

For example, if one group of CSI-RS resources included in the sub-configuration includes a subset of group1 and a subset of group2, one resource of each CMR pair configured by the CMR pair configuration is a resource of the subset of group1, and the other resource of each CMR pair configured by the CMR pair configuration is a resource of the subset of group2.

For another example, the resource groups associated with the CSI report configuration include group1 and group2, group1 includes resource1, resource2, and resource3, and group2 includes resource4 and resource5; and the sub-configuration includes one NZP-CSI-RS-ResourceList, and a number of resources of NZP-CSI-RS-ResourceList in the sub-configuration is equal to a number of resources associated with the CSI report configuration. That is, in this example, the number of resources associated with the CSI report configuration is 5, where when first three resources correspond to group1, and last two resources correspond to group2, NZP-CSI-RS-ResourceList in the sub-configuration is also configured with five resources, first three resources correspond to group1, and last two resources correspond to group2. If resource1 and resource4 associated with the CSI report configuration are one CMR pair, resource2 and resource15 are one CMR pair, NZP-CSI-RS-ResourceList of the sub-configuration includes resource1, resource3, resource6, resource4, and resource8, and in the sub-configuration, resource1 and resource4 are one CMR pair, and resource3 and resource8 are one CMR pair. It should be noted that in this example, the resource (namely, the resource associated with the CSI report configuration) in the resource setting in the CSI report configuration is not necessarily related to the resource (namely, the resource of NZP-CSI-RS-ResourceList) in the sub-configuration, but the sub-configuration can learn of, based on a number of resources of group1 and group2 of the CSI report configuration, that in NZP-CSI-RS-ResourceList of the sub-configuration, first three resources correspond to resources of TRP0, and last two resources correspond to resources of TRP1. In addition, in this example, a new CMR pair is configured in the sub-configuration. It should be noted that the new CMR pair may not be configured in the sub-configuration, so the terminal distinguishes, based on a pairing relationship of the CMR pair configured in the CSI report configuration, which two resources in NZP-CSI-RS-ResourceList are one CMR pair. In this example, if the sub-configuration is not configured with the new CMR pair, the terminal can distinguish that resource1 and resource4 of NZP-CSI-RS-ResourceList are one CMR pair.

For another example, the resource groups associated with the CSI report configuration include group1 and group2, group1 includes resource1, resource2, and resource3, and group2 includes resource4 and resource5. The resources associated with the CSI report configuration include resources of all the sub-configurations. For example, the resources associated with the CSI report configuration are a complete set of the resources of all the sub-configurations, and CMR pairs of the CSI report configuration include CMR pairs of all the sub-configurations. For example, the CMR pairs of the CSI report configuration are a complete set of CMR pairs of all the sub-configurations. The sub-configuration includes one NZP-CSI-RS-ResourceList, and resources in NZP-CSI-RS-ResourceList in the sub-configuration are a subset of the resources associated with the CSI report configuration. If NZP-CSI-RS-ResourceList includes resource1, resource2, and resource4, based on the CSI report configuration, the terminal can learn of that resource1 and resource2 of NZP-CSI-RS-ResourceList are resources belonging to group1, and resource4 of NZP-CSI-RS-ResourceList is a resource belonging to group2. If resource1 and resource4 in the resource set associated with the CSI report configuration are one CMR pair, and resource2 and resource5 are one CMR pair, the terminal may understand, based on a pairing relationship of the CMR of the CSI report configuration, that resource1 and resource4 are a CMR pair in the sub-configuration, resource1 and resource2 belong to group1, and resource4 belongs to group2. In this example, there is no need to configure a new CMR pair in the sub-configuration, and resources in the sub-configuration are a subset of the resources associated with the CSI report configuration, so the CMR pair corresponding to the sub-configuration is also a subset of a CMR pair corresponding to the CSI report configuration, that is, the CSI report configuration should be equipped with resources of all the sub-configurations and CMR pairs of all the sub-configurations.

Optionally, before the reporting, by the terminal, a CSI report based on the CSI report configuration, the method further includes:
when the sub-configuration includes a port subset indicator, a CBSR, an RI restriction, and a power offset value, calculating, by the terminal, the CSI of the sub-configuration based on that a port state of all CSI-RS resources associated with the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value for each resource associated with the CSI report configuration is increased or decreased by the power offset value included in the sub-configuration;
or
when the sub-configuration includes at least one group of CSI-RS resources and a power offset value, calculating, by the terminal, the CSI of the sub-configuration based on that the at least one group of CSI-RS resources included in the sub-configuration is used as a measurement resource, and a power control offset value of each resource of the at least one group of CSI-RS resources included in the sub-configuration is increased or decreased by the power offset value included in the sub-configuration;
or
when the sub-configuration includes a port subset indicator, a CBSR, an RI restriction, at least one group of CSI-RS resources, and a power offset value, calculating, by the terminal, the CSI of the sub-configuration based on that the at least one group of CSI-RS resources included in the sub-configuration is used as a measurement resource, a port state of the at least one group of CSI-RS resources included in the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value of each resource of the at least one group of CSI-RS resources included in the sub-configuration is increased or decreased by the power offset value included in the sub-configuration;
or
when the sub-configuration includes a port subset indicator, a CBSR, an RI restriction, at least one group of CSI-RS resources, and a power offset value, performing, by the terminal, at least one of the following:
calculating single TRP CSI of a first resource group based on that a port state of a resource of a first resource group is a port state indicated by the port subset indicator, an RI restriction for single TRP CSI calculation of the first resource group is the RI restriction included in the sub-configuration, a CBSR for single TRP CSI calculation of the first resource group is the CBSR included in the sub-configuration, and a power control offset value of each resource of the first resource group is increased or decreased by the power offset value included in the sub-configuration;
calculating single TRP CSI of a second resource group based on that a resource of the at least one group of CSI-RS resources is used as a measurement resource of single TRP CSI of a second resource group, and a power control offset value of each resource of the at least one group of CSI-RS resources is increased or decreased by the power offset value included in the sub-configuration; and
calculating, based on that a port state of a resource of a first resource group is a port state indicated by the port subset indicator, a resource of the at least one group of CSI-RS resources is used as a measurement resource of a second resource group, an RI restriction for multi-TRP CSI calculation is the RI restriction included in the sub-configuration or an RI restriction included in the CSI report configuration, a CBSR for multi-TRP CSI calculation is the CBSR included in the sub-configuration or a CBSR included in the CSI report configuration, and a power control offset value of each resource of the first resource group and a power control offset value of each resource of the at least one group of CSI-RS resources are increased or decreased by the power offset value included in the sub-configuration, the multi-TRP CSI, where
the first resource group and the second resource group are different resource groups of the N resource groups;
or
when the sub-configuration does not include the CMR pair configuration information, calculating, by the terminal, multi-TRP CSI of the sub-configuration based on CMR pair configuration information in a resource setting associated with the CSI report configuration;
or
when the sub-configuration includes the CMR pair configuration information, calculating, by the terminal, multi-TRP CSI of the sub-configuration based on the CMR pair configuration information included in the sub-configuration.

In an implementation, when the sub-configuration includes a port subset indicator, a CBSR, an RI restriction, and a power offset value, the terminal may calculate CSI of the sub-configuration based on or referring to the port subset indicator, the CBSR, the RI restriction, and the power offset value included in the sub-configuration. Specifically, the terminal may calculate the CSI of the sub-configuration based on that a port state of all CSI-RS resources associated with the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value for each resource associated with the CSI report configuration is increased or decreased by the power offset value included in the sub-configuration. That is, the port subset indicator, the CBSR, the RI restriction, and the power offset value included in the sub-configuration are applied to the N resource groups associated with the CSI report configuration.

In another implementation, when the sub-configuration includes at least one group of CSI-RS resources and a power offset value, the terminal calculates CSI of the sub-configuration based on or referring to the at least one group of CSI-RS resources and the power offset value included in the sub-configuration. Specifically, the terminal may calculate the CSI of the sub-configuration based on that the at least one group of CSI-RS resources included in the sub-configuration is used as a measurement resource, and a power control offset value of each resource of the at least one group of CSI-RS resources included in the sub-configuration is increased or decreased by the power offset value included in the sub-configuration.

In still another implementation, when the sub-configuration includes a port subset indicator, a CBSR, an RI restriction, at least one group of CSI-RS resources, and a power offset value, the terminal may calculate the CSI of the sub-configuration based on or referring to the port subset indicator, the CBSR, the RI restriction, the at least one group of CSI-RS resources, and the power offset value included in the sub-configuration. Specifically, the terminal may calculate the CSI of the sub-configuration based on or referring to that the at least one group of CSI-RS resources included in the sub-configuration is used as a measurement resource, a port state of the at least one group of CSI-RS resources included in the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value of each resource of the at least one group of CSI-RS resources included in the sub-configuration is increased or decreased by the power offset value included in the sub-configuration. That is, if the sub-configuration includes related parameters of Type I shutdown (a port subset indicator, a CBSR, and an RI restriction), related parameters of Type II shutdown (at least one list of CSI-RS resources), and a power offset value, the related parameters of Type I shutdown may be applied to one list of resources represented by Type II shutdown.

In yet another implementation, when the sub-configuration includes a port subset indicator, a CBSR, an RI restriction, at least one group of CSI-RS resources, and a power offset value, the terminal may calculate the CSI of the sub-configuration based on or referring to the port subset indicator, the CBSR, the RI restriction, the at least one group of CSI-RS resources, and the power offset value included in the sub-configuration.

Specifically, the terminal calculates single TRP CSI (namely, s-TRP CSI) of a first resource group based on that a port state of a resource of a first resource group is a port state indicated by the port subset indicator, an RI restriction for single TRP CSI calculation of the first resource group is the RI restriction included in the sub-configuration, a CBSR for single TRP CSI calculation of the first resource group is the CBSR included in the sub-configuration, and a power control offset value of each resource of the first resource group is increased or decreased by the power offset value included in the sub-configuration; or the terminal may calculate s-TRP CSI of a second resource group based on that a resource of the at least one group of CSI-RS resources is used as a measurement resource of single TRP CSI of a second resource group, and a power control offset value of each resource of the at least one group of CSI-RS resources is increased or decreased by the power offset value included in the sub-configuration; or the terminal may calculate, based on that a port state of a resource of a first resource group is a port state indicated by the port subset indicator, a resource of the at least one group of CSI-RS resources is used as a measurement resource of the second resource group, an RI restriction for multi-TRP CSI calculation is the RI restriction included in the sub-configuration or an RI restriction included in the CSI report configuration, a CBSR for multi-TRP CSI calculation is the CBSR included in the sub-configuration or a CBSR included in the CSI report configuration, and a power control offset value of each resource of the first resource group and a power control offset value of each resource of the at least one group of CSI-RS resources are increased or decreased by the power offset value included in the sub-configuration, the multi-TRP CSI (namely, M-TRP CSI), for example, NCJT CSI. That a resource of the at least one group of CSI-RS resources is used as a measurement resource of the second resource group can be understood as that a resource used for multi-TRP CSI measurement in the second resource group is the resource of the at least one group of CSI-RS resources.

It should be noted that the CSI of the sub-configuration includes at least one of the following: single TRP CSI of the first resource group, s-TRP CSI of the second resource group, and multi-TRP CSI (namely, NCJT CSI).

Optionally, the method further includes: when the sub-configuration includes the first identifier, determining, by the terminal based on the first identifier, the resource group associated with the sub-configuration. The resource group associated with the sub-configuration can be understood as a resource group to which the sub-configuration is applied.

This embodiment of this application is described below by using examples.

Example 1: The sub-configuration includes an identifier for distinguishing different TRPs or different resource groups.

In this example, the sub-configuration includes a bitmap of two bits to distinguish different resource groups. Specifically, the UE is configured with five csi-ReportConfigs (namely, the CSI report configuration), each csi-ReportConfig has an associated resource set (namely, resource set) for channel measurement, each resource set includes multiple resources, and RRC configures these multiple resources to be divided into two resource groups, namely, group1 and group2, where different resource groups represent different TRPs. In this example, the resource set includes five resources, first three resources belong to group1, and last two resources belong to group2.

csi-ReportConfig may be configured with multiple sub-configurations, that is, csi-ReportConfig is associated with multiple sub-configurations. In this example, each of csi-ReportConfig0, and csi-ReportConfig2 to csi-ReportConfig5 includes one sub-configuration, and csi-ReportConfig1 includes three sub-configurations. Each sub-configuration includes one resource group bitmap (resourceGroupBitmap), to distinguish different TRPs or different resource groups in the resource setting associated with csi-ReportConfig, where ‘01’ represents that the sub-configuration is associated with a resource of group1, corresponding to TRP0; ‘10’ represents that the sub-configuration is associated with a resource of group2, corresponding to TRP1; and ‘11’ represents that the sub-configuration is associated with all resources in the resource set, corresponding to m-TRP, that is, corresponding to TRP0 and TRP1.

Specifically, related content of the sub-configuration included in each csi-ReportConfig can be shown in Table 1.

TABLE 1

| CSI report | | Parameter included | |
|---|---|---|---|
| configuration | Sub-configuration | in the sub-configuration | Value |
| csiReportConfig0 | csi-ReportSubConfig0 | resourceGroupBitmap | 01 |
| | | port-subsetIndicator | |
| | | RI restriction | |
| | | CBSR | |
| | | deltapowerControlOffset | |
| csiReportConfig1 | csi-ReportSubConfig1 | resourceGroupBitmap | 01 |
| | | CSI-RS-ResourceList | |
| | | deltapowerControlOffset | |
| | csi-ReportSubConfig2 | resourceGroupBitmap | 10 |
| | | CSI-RS-ResourceList | |
| | | deltapowerControlOffset | |
| | csi-ReportSubConfig3 | resourceGroupBitmap | 10 |
| | | CSI-RS-ResourceList | |
| | | deltapowerControlOffset | |
| csiReportConfig2 | csi-ReportSubConfig4 | resourceGroupBitmap | 11 |
| | | port-subsetIndicator | |
| | | RI restriction | |
| | | CBSR | |
| | | deltapowerControlOffset | |
| csiReportConfig3 | csi-ReportSubConfig5 | resourceGroupBitmap | 01 |
| | | CSI-RS-ResourceList1 | |
| | | CSI-RS-ResourceList2 | |
| | | deltapowerControlOffset1 | |
| | | deltapowerControlOffset2 | |
| csiReportConfig4 | csi-ReportSubConfig6 | resourceGroupBitmap | 11 |
| | | port-subsetIndicator | |
| | | RI restriction | |
| | | CBSR | |
| | | CSI-RS-ResourceList | |
| | | resourcePairing | |
| | | deltapowerControlOffset1 | |
| | | deltapowerControlOffset2 | |
| csiReportConfig5 | csi-ReportSubConfig7 | resourceGroupBitmap | 11 |
| | | port-subsetIndicator | |
| | | RI restriction | |
| | | CBSR | |
| | | CSI-RS-ResourceList | |
| | | deltapowerControlOffset1 | |
| | | deltapowerControlOffset2 | |

Referring to Table 1, a value of resourceGroupBitmap included in csi-ReportSubConfig0 is ‘01’, which can be understood as that the sub-configuration is associated with a 1^{st} resource group in a resource set associated with csiReportConfig0, that is, an application scope of the sub-configuration is resources in group1. In this case, the sub-configuration calculates the CSI of the sub-configuration based on that a port state of a resource in group1 is updated to a port open/closed state indicated by port-subsetIndicator, the RI restriction and the CBSR used for CSI calculation of the sub-configuration are updated to parameter values of corresponding parameters in the sub-configuration, and powerControlOffset of an NZP CSI-RS resource in group1 (for example, an energy per resource element (EPRE) of a PDSCH relative to a CSI-RS) is increased or decreased by deltapowerControlOffset.

A value of resourceGroupBitmap included in csi-ReportSubConfig1 is ‘01’, which can be understood as that the sub-configuration is associated with a 1^{st} resource group in a resource set associated with csiReportConfig1, that is, an application scope of the sub-configuration is resources in group1. In this case, the sub-configuration calculates the CSI of the sub-configuration based on that NZP-CSI-RS-ResourceList of the sub-configuration is used as a measurement resource, and powerControlOffset of all resources is increased or decreased by deltapowerControlOffset.

A value of resourceGroupBitmap included in csi-ReportSubConfig2 is ‘10’, which can be understood as that the sub-configuration is associated with a 2^{nd} resource group in a resource set associated with csiReportConfig1, that is, an application scope of the sub-configuration is resources in group2. In this case, the sub-configuration calculates the CSI of the sub-configuration based on that a port state of a resource in group2 is updated to a port open/closed state indicated by port-subsetIndicator, the RI restriction and the CBSR used for CSI calculation of the sub-configuration are updated to parameter values of corresponding parameters in the sub-configuration, and powerControlOffset of the resource in group2 is increased or decreased by deltapowerControlOffset.

A value of resourceGroupBitmap included in csi-ReportSubConfig3 is ‘10’, which can be understood as that the sub-configuration is associated with a 2^{nd} resource group in a resource set associated with csiReportConfig1, that is, an application scope of the sub-configuration is resources in group2. In this case, the sub-configuration calculates the CSI of the sub-configuration based on that NZP-CSI-RS-ResourceList in the sub-configuration is used as a measurement resource, and powerControlOffset of all resources (namely, resources of NZP-CSI-RS-ResourceList) is increased or decreased by deltapowerControlOffset.

A value of resourceGroupBitmap included in csi-ReportSubConfig4 is ‘11’, which can be understood as that the sub-configuration is associated with two resource groups in a resource set associated with csiReportConfig2, that is, an application scope of the sub-configuration is resources in the two resource groups. In this case, the sub-configuration calculates the CSI of the sub-configuration based on that a port state of all resources in the resource set is updated to a port open/closed state indicated by port-subsetIndicator, the RI restriction and the CBSR used for CSI calculation of the sub-configuration are updated to parameter values of corresponding parameters in the sub-configuration, powerControlOffsets of all the resources in the resource set are increased or decreased by deltapowerControlOffset, and resource pairing used for NCJT CSI calculation follows a CMR pair configured in the CSI report configuration, where the CSI of the sub-configuration is m-TRP CSI.

It should be noted that in this configuration, there may be configured with two RI restrictions, CBSRs, and deltapowerControlOffsets, to be applied to resources of group1 and resources of group2 respectively. That CMR pairing follows a CMR pair configured in the CSI report configuration refers to that in the CSI report configuration, group1 includes resource1, 2, 3, group2 includes resource4, 5, and resource1 and resource4 are configured as one CMR pair in the CSI report configuration. When resource2 and resource5 are one CMR pair, in the sub-configuration, resource1 and resource4 are still one CMR pair, and resource2 and resource5 are one CMR pair, but a port state of the CMR pair in the sub-configuration is changed to the closed/open state indicated by port-subsetIndicator.

It should be further noted that in addition to following the CMR pair configured in the CSI report configuration, the CMR pair of the sub-configuration may also be directly configured in the sub-configuration.

A value of resourceGroupBitmap included in si-ReportSubConfig5 is ‘11’, which can be understood as that the sub-configuration is associated with two resource groups in a resource set associated with csiReportConfig3, that is, an application scope of the sub-configuration is resources in the two resource groups. In this case, the sub-configuration calculates the CSI of the sub-configuration based on that NZP-CSI-RS-ResourceList1 in the sub-configuration is used as a measurement resource of TRP0 (group1), powerControlOffsets of all resources of NZP-CSI-RS-ResourceList1 are increased or decreased by deltapowerControlOffset1, NZP-CSI-RS-ResourceList2 is used as a measurement resource of TRP1 (group2), and powerControlOffsets of all resources of NZP-CSI-RS-ResourceList2 are increased or decreased by deltapowerControlOffset2, where the CSI of the sub-configuration is m-TRP CSI.

It should be noted that two power domain adaptation parameters: deltapowerControlOffset, may be configured to be applied to the two resource groups respectively, such as csi-ReportSubConfig5, or only one deltapowerControlOffset may be configured, that is, values of deltapowerControlOffset of the two resource groups are increased or decreased by deltapowerControlOffset. deltapowerControlOffset may be equal to powerOffset in the RRC parameters.

It should be further noted that in this configuration, resources in NZP-CSI-RS-ResourceList1 are a subset of resources in group1 in the CSI report configuration. If it is assumed that resource1 and resource2 are included, resources in NZP-CSI-RS-ResourceList2 are a subset of resources in group2 in the CSI report configuration. If it is assumed that resource4 is included, the CMR pair configured in the CSI report configuration is followed, and resource1 and resource4 are one CMR pair in the sub-configuration.

It should be further noted that in addition to directly following the CMR pair configured in the CSI report configuration, a new CMR pair may also be configured in the sub-configuration.

It should be further noted that if the value of resourceGroupBitmap is ‘10’ or ‘01’, that is, if the sub-configuration is applied to only a single TRP or a single resource group, only a single NZP CSI-RS resource list is optionally configured in the sub-configuration, that is, CSI calculation of the sub-configuration is performed based on the single NZP CSI-RS resource list; and if the value of resourceGroupBitmap is ‘11’, that is, if the sub-configuration is applied to two resource groups or two TRPs, one or two NZP CSI-RS resource lists may be configured. For a specific configuration mode, refer to related description in the foregoing embodiment, and details are not described herein again.

A value of resourceGroupBitmap included in csi-ReportSubConfig6 is ‘11’, which can be understood as that the sub-configuration is associated with two resource groups in a resource set associated with csiReportConfig4. Because the sub-configuration includes both related parameters of Type I shutdown and related parameters of Type II shutdown, it needs to be further distinguished a TRP or resource group to which the related parameters of Type I shutdown are applied and a TRP or resource group to which the related parameters of Type II shutdown are applied. An optional implementation is to perform Type I shutdown for group1 by default and apply the related parameters of Type I shutdown, and perform Type II shutdown for group2 by default and apply the related parameters of Type II shutdown, or perform Type II shutdown for group1 by default and apply the related parameters of Type II shutdown, and perform Type I shutdown for group2 by default and apply the related parameters of Type I shutdown. In this case, the UE calculates the CSI of the sub-configuration based on that a port state of a resource in group1 is updated to a port open/closed state indicated by port-subsetIndicator, the RI restriction and the CBSR used for CSI calculation of the sub-configuration are updated to parameter values of corresponding parameters in the sub-configuration, powerControlOffset of the resource in group1 is increased or decreased by deltapowerControlOffset1, the resource of NZP-CSI-RS-ResourceList in the sub-configuration is used as a measurement resource corresponding to group2, and powerControlOffsets of all resources in NZP-CSI-RS-ResourceList are increased or decreased by deltapowerControlOffset2.

It should be noted that two power domain adaptation parameters: deltapowerControlOffset, may be configured to be applied to the two resource groups respectively, or only one deltapowerControlOffset may be configured, that is, values of deltapowerControlOffset of the two resource groups are increased or decreased by deltapowerControlOffset.

A value of resourceGroupBitmap included in csi-ReportSubConfig7 is ‘11’, which can be understood as that the sub-configuration is associated with two resource groups in a resource set associated with csiReportConfig5. The sub-configuration is the same as a configuration of csi-ReportSubConfig6 in form, but the terminal has different understanding for the sub-configuration. For csi-ReportSubConfig7, the understanding of UE is that the related parameters of Type I shutdown are all applied to NZP-CSI-RS-ResourceList included in the sub-configuration, that is, the UE uses NZP-CSI-RS-ResourceList in the sub-configuration as a resource for m-TRP measurement, the port state of the resource of NZP-CSI-RS-ResourceList is updated to the port open/closed state indicated by port-subsetIndicator, the RI restriction and the CBSR used for CSI calculation are updated to parameter values of corresponding parameters in the sub-configuration, powerControlOffset of a resource in group1 is increased or decreased by deltapowerControlOffset1, and powerControlOffsets of all resources in group2 are increased or decreased by deltapowerControlOffset2, to calculate the CSI of the sub-configuration, where the sub-configuration is m-TRP CSI.

It should be noted that in this example, the UE may not report the CSI corresponding to the csi-ReportConfig. In addition, the network side may trigger CSI reporting of one or more sub-configurations of the csi-ReportConfig through DCI or a MAC CE.

Example 2: Multiplex the existing R18 framework to report m-TRP CSI.

In this example, the sub-configuration does not include an identifier for distinguishing different TRPs or an identifier for distinguishing different resource groups, but follows the existing framework of R18, and has a different interpretation for the framework.

Specifically, in this example, the UE is configured with four csi-ReportConfigs (namely, the CSI report configuration), each csi-ReportConfig is associated with a resource set (namely, resource set) for channel measurement, the resource set includes multiple resources, and RRC configures these multiple resources to be divided into two resource groups, namely, group1 and group2, where different resource groups represent different TRPs. In this example, the resource set includes five resources, first three resources belong to group1, and last two resources belong to group2.

csi-ReportConfig may be configured with one or more sub-configurations, that is, csi-ReportConfig is associated with multiple sub-configurations. In this example, each csi-ReportConfig includes one sub-configuration, and parameters in each sub-configuration are applied to all resources associated with csi-ReportConfig, that is, applied to two resource groups.

Specifically, related content of the four sub-configurations can be shown in Table 2.

TABLE 2

| CSI report | | Parameter included |
|---|---|---|
| configuration | Sub-configuration | in the sub-configuration |
| csiReportConfig0 | csi-ReportSubConfig0 | port-subsetIndicator |
| | | RI restriction |
| | | CBSR |
| | | deltapowerControlOffset |
| csiReportConfig1 | csi-ReportSubConfig1 | CSI-RS-ResourceList |
| | | deltapowerControlOffset |
| csiReportConfig2 | csi-ReportSubConfig2 | CSI-RS-ResourceList |
| | | port-subsetIndicator |
| | | RI restriction |
| | | CBSR |
| | | deltapowerControlOffset |
| csiReportConfig3 | csi-ReportSubConfig3 | CSI-RS-ResourceList1 |
| | | CSI-RS-ResourceList2 |
| | | deltapowerControlOffset1 |
| | | deltapowerControlOffset2 |

For csi-Report SubConfig0, the UE calculates the CSI of the sub-configuration based on that port states of all resources in the two resource groups associated with csiReportConfig0 are updated to the port open/closed state indicated by port-sub setIndicator, the RI restriction and the CBSR used for CSI calculation of the sub-configuration are updated to parameter values of corresponding parameters in the sub-configuration, and powerControl Offsets of the resources of the two resource groups (for example, an EPRE of a PDSCH relative to a CSI-RS) are increased or decreased by deltapowerControl Offset, where the CSI of the sub-configuration is m-TRP CSI.

It should be noted that two power domain adaptation parameters: deltapowerControl Offset, may be configured to be applied to the two resource groups respectively, or only one deltapowerControl Offset may be configured, that is, values of deltapowerControl Offset of the two resource groups are increased or decreased by deltapowerControl Offset.

Corresponding to csi-ReportSubConfig1, the UE calculates the CSI of the sub-configuration based on that NZP-CSI-RS-ResourceList in the sub-configuration is used as a measurement resource of m-TRP CSI, and powerControlOffsets of all resources of NZP-CSI-RS-ResourceList are increased or decreased by deltapowerControlOffset.

It should be noted that two power domain adaptation parameters: deltapowerControlOffset, may be configured to be applied to the two resource groups respectively, or only one deltapowerControlOffset may be configured, that is, values of deltapowerControlOffset of the two resource groups are increased or decreased by deltapowerControlOffset.

It should be further noted that for the configuration mode of NZP-CSI-RS-ResourceList in the sub-configuration, refer to related description in the foregoing embodiment, and details are not described herein again.

For csi-ReportSubConfig2, the UE calculates the CSI of the sub-configuration based on that NZP-CSI-RS-ResourceList in the sub-configuration is used as a resource for m-TRP CSI measurement, port states of all resources of NZP-CSI-RS-ResourceList in the sub-configuration are updated to the port open/closed state indicated by port-subsetIndicator, the RI restriction and the CBSR used for CSI calculation of the sub-configuration are updated to parameter values of corresponding parameters in the sub-configuration, powerControlOffsets of resources of the two resource groups are increased or decreased by deltapowerControlOffset, where the CSI of the sub-configuration is m-TRP CSI.

It should be noted that in this configuration, one sub-configuration includes both the related parameters of Type I shutdown (CBSR, RI restriction, port-subsetIndicator) and the related parameters of Type II shutdown (a list of CSI-RS resources). The understanding of the UE is that all the related parameters of Type I shutdown are applied to resources indicated by the related parameters of Type II shutdown included in the sub-configuration, that is, all the related parameters of Type I shutdown are applied to resources configured in the sub-configuration. Alternatively, the understanding of the UE is that the related parameters of Type I shutdown are applied to only TRP 0, and the related parameters of Type II shutdown are applied to only TRP1.

In this example, there may be three configuration modes of NZP-CSI-RS-ResourceList as follows.

Mode 1: Configure two NZP-CSI-RS-ResourceLists (for example, sub-config3 in this example) in the sub-configuration, to cover the two resource groups in the CSI report configuration respectively, where resources in these two NZP-CSI-RS-ResourceLists respectively come from subsets of different resource groups in the CSI report configuration. In this example, when group1 includes three resources, and group2 includes two resources, a number of resources in NZP-CSI-RS-ResourceList1 in the sub-configuration is less than or equal to 3, and resources in NZP-CSI-RS-ResourceList1 are a subset of resources in group1; and a number of resources in NZP-CSI-RS-ResourceList2 in the sub-configuration is less than or equal to 2, and resources in NZP-CSI-RS-ResourceList2 are a subset of resources in group2.

Mode 2: Configure only one NZP-CSI-RS-ResourceList in the sub-configuration, where a number of resources of NZP-CSI-RS-ResourceList in the sub-configuration is equal to a number of resources in the CSI report configuration. That is, in this example, the number of resources associated with the CSI report configuration is 5, where when first three resources correspond to group1, and last two resources correspond to group2, NZP-CSI-RS-ResourceList in the sub-configuration is also configured with five resources, first three resources correspond to group1, and last two resources correspond to group2.

Mode 3: Configure only one NZP-CSI-RS-ResourceList in the sub-configuration, where NZP-CSI-RS-ResourceList is a subset of the resource set of the CSI report configuration. In other words, a resource set of a resource setting of the CSI report configuration includes resources of all the sub-configurations. For example, resources in the resource set of the resource setting of the CSI report configuration are a complete set of NZP-CSI-RS-ResourceList of all the sub-configurations, and have been divided into groups. Because the resources in the resource set have been divided into groups, that is, resources of group1 and group2 have been divided, such as resource1, resource2, and resource3 belong to group1, and resource4 and resource5 belong to group2, and the resources in NZP-CSI-RS-ResourceList configured in the sub-configuration are a subset of the resources configured in the CSI report configuration, for example, NZP-CSI-RS-ResourceList is configured with resource1, resource2, and resource4. In this case, based on the RRC configuration, the UE can learn of that resource1 and resource2 are resources belonging to group1, and resource4 is a resource belonging to group2.

Optionally, before the reporting, by the terminal, a CSI report based on the CSI report configuration, the method further includes:
when the sub-configuration includes the CSI report mode or the number of pieces of single TRP CSI reported when the CSI report mode is the first mode, determining, by the terminal based on the CSI report mode or the number of pieces of single TRP CSI reported when the CSI report mode is the first mode included in the sub-configuration, CSI that needs to be reported by the sub-configuration;
or
when the sub-configuration does not include the CSI report mode or the number of pieces of single TRP CSI reported when the CSI report mode is the first mode, determining, by the terminal based on a CSI report mode configured by the CSI report configuration or the number of pieces of single TRP CSI reported in the first mode, CSI that needs to be reported by the sub-configuration;
or
when the sub-configuration does not include the CSI report mode or the number of pieces of single TRP CSI reported in the first mode, determining, by the terminal based on the first identifier, CSI that needs to be reported by the sub-configuration, where when the first identifier indicates one resource group, the CSI that needs to be reported by the sub-configuration includes single TRP CSI corresponding to the resource group indicated by the first identifier, and when the first identifier indicates at least two resource groups, the CSI that needs to be reported by the sub-configuration includes multi-TRP CSI corresponding to the at least two resource groups indicated by the first identifier.

In an implementation, when the sub-configuration includes csi-ReportMode or numberOfSingleTRP-CSI-Mode1, the terminal determines, based on csi-ReportMode or numberOfSingleTRP-CSI-Mode1 included in the sub-configuration, CSI that needs to be reported by the sub-configuration. For example, if csi-ReportMode included in the sub-configuration indicates that the CSI reporting mode is mode1, and a value of numberOfSingleTRP-CSI-Mode1 included in the sub-configuration is M, the sub-configuration needs to report NCJT CSI and M pieces of s-TRP CSI; and if csi-ReportMode included in the sub-configuration indicates that the CSI reporting mode is mode2, the sub-configuration needs to report best CSI in NCJT CSI and s-TRP CSI.

In another implementation, when the sub-configuration does not include csi-ReportMode or numberOfSingleTRP-CSI-Mode1, the terminal determines, based on csi-ReportMode or numberOfSingleTRP-CSI-Mode1 included in the CSI report configuration, CSI that needs to be reported by the sub-configuration. For example, if csi-ReportMode included in the CSI report configuration indicates that the CSI reporting mode is mode1, and the value of numberOfSingleTRP-CSI-Mode1 included in the CSI report configuration is K, the sub-configuration needs to report NCJT CSI and K pieces of s-TRP CSI; and if csi-ReportMode included in the CSI report configuration indicates that the CSI reporting mode is mode2, the sub-configuration needs to report best CSI in NCJT CSI and s-TRP CSI.

In still another implementation, when the sub-configuration does not include csi-ReportMode or numberOfSingleTRP-CSI-Mode1, the terminal determines, based on the first identifier, CSI that needs to be reported by the sub-configuration. For example, if resourceGroupBitmap indicates a single resource group, the UE reports CSI of s-TRP of the single resource group, and if resourceGroupBitmap is two resource groups, the UE reports m-TRP CSI. For another example, when values of resourceGroupBitmap are ‘01’ and ‘10’, CSI of s-TRP of a corresponding resource group is reported, and when the value of resourceGroupBitmap is ‘11’, m-TRP NCJT CSI corresponding to the CMR pair is reported.

Optionally, when the CSI report includes CSI of at least two sub-configurations, the CSI of the at least two sub-configurations is mapped in ascending order of identifiers of the at least two sub-configurations.

In this embodiment, a mapping order of the at least two sub-configurations may be determined based on the identifiers of the at least two sub-configurations. Specifically, the CSI of the at least two sub-configurations is mapped in ascending order of the identifiers of the at least two sub-configurations. For example, if the CSI report includes CSI from csi-ReportSubConfig0 to csi-ReportSubConfig5, the CSI from csi-ReportSubConfig0 to csi-ReportSubConfig5 may be mapped in sequence.

Optionally, CSI part1 of the CSI report includes at least two sub-configuration CSIs' CSI part1, and the at least two sub-configuration CSIs' CSI part1 is mapped in ascending order of the identifiers of the at least two sub-configurations.

In this embodiment, CSI part1 is part1 CSI. For example, as shown in Table 3, for CSI part1, part1 CSI of multiple csi-ReportSubconfigs in a single CSI report is arranged in an order of sub-configuration Id.

TABLE 3

| | CSI report number and sub-configuration report number | |
|---|---|---|
| UCI bit sequence | (sub-config report number) | Annotation |
| ${a}_{0}^{( 2 )}$ | CSI report #1, CSI sub-config report #1, CSI part 2 wideband | Wideband information |
| ${a}_{1}^{( 2 )}$ | CSI report #1, CSI sub-config report #2, CSI part 2 wideband | |
| | . . . | |
| ${a}_{2}^{( 2 )}$ | CSI report #1, CSI sub-config report #M, CSI part 2 wideband | |
| ${a}_{3}^{( 2 )}$ | CSI report #2, CSI sub-config report #1, CSI part 2 wideband | |
| . . . | CSI report #2, CSI sub-config report #2, CSI part 2 | |
| | wideband | |
| | . . . | |
| ${a}_{{A}^{( 2 )} - 1}^{( 2 )}$ | CSI report #2, CSI sub-config report #L, CSI part 2 wideband | |
| | . . . | |
| | CSI report #1, CSI sub-config report #1, CSI part 2 | Even |
| | even subband | subband CSI |
| | CSI report #1, CSI sub-config report #2, CSI part 2 | part 2 of CSI |
| | even subband | report #1 |
| | . . . | |
| | CSI report #1, CSI sub-config report #M, CSI part 2 | |
| | even subband | |
| | CSI report #1, CSI sub-config report #1, CSI part 2 odd | Odd subband |
| | subband | CSI part 2 of |
| | CSI report #1, CSI sub-config report #2, CSI part 2 odd | CSI report |
| | subband | #1 |
| | . . . | |
| | CSI report #1, CSI sub-config report #M, CSI part 2 | |
| | odd subband | |
| | CSI report #2, CSI sub-config report #1, CSI part 2 | Even |
| | even subband | subband CSI |
| | CSI report #2, CSI sub-config report #2, CSI part 2 | part 2 of CSI |
| | even subband | report #2 |
| | . . . | |
| | CSI report #2, CSI sub-config report #L, CSI part 2 | |
| | even subband | |
| | CSI report #2, CSI sub-config report #1, CSI part 2 odd | Odd subband |
| | subband | CSI part 2 of |
| | CSI report #2, CSI sub-config report #2, CSI part 2 odd | CSI report |
| | subband | #2 |
| | . . . | |
| | CSI report #2, CSI sub-config report #L, CSI part 2 odd | |
| | subband | |
| | . . . | |

Optionally, a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and

a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations.

In this embodiment, CSI part2 is part2 CSI. The wideband CSI of CSI part2 is CSI part2 wideband. The subband CSI of CSI part2 is CSI part2 subband. The even subband CSI of CSI part2 is CSI part2 even subband. The odd subband CSI of CSI part2 is CSI part2 odd subband.

For example, as shown in Table 3, for CSI part2 wideband, CSI part2 widebands of multiple csi-ReportSubconfigs in a single CSI report are arranged in ascending order of the sub-configuration Id; and for CSI part2 subband, CSI part2 even subbands of multiple csi-ReportSubconfigs in a single CSI report are arranged in ascending order of the sub-configuration Id. CSI part2 odd subbands of multiple csi-ReportSubconfigs in a single CSI report are arranged in ascending order of the sub-configuration Id, and in the single CSI report, even subbands of all sub-configurations are arranged before odd subbands of all the sub-configurations.

Optionally, the CSI report configuration is associated with at least two sub-configurations, and the method further includes:
omitting or discarding, by the terminal, a part or all of CSI part2 of the at least two sub-configurations based on a mapping order of CSI part2 of the at least two sub-configurations, where
the mapping order of CSI part2 of the at least two sub-configurations is determined based on an order of the identifiers of the at least two sub-configurations.

In this embodiment, when uplink resources are insufficient, CSI part2 of the multiple sub-configurations associated with the CSI report configuration is discarded based on a granularity or a level of the sub-configuration. CSI part2 even subband of CSI of different sub-configurations may have different priorities, and CSI part2 odd subband of CSI of different sub-configurations may have different priorities.

For example, refer to Table 3. Except for upper wideband information, each line in Table 3 represents a priority level, which may be discarded or omitted line by line from bottom to top.

Optionally, when the CSI of the sub-configuration includes at least two pieces of CSI, a mapping order of even subband CSI of CSI part2 of the at least two pieces of CSI is before a mapping order of odd subband CSI of CSI part2 of the at least two pieces of CSI, where
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol.

In this embodiment, the multi-TRP CSI is, for example, NCJT CSI.

For example, when the CSI of the sub-configuration includes NCJT CSI and s-TRP CSI, CSI part2 even subbands of the NCJT CSI and the s-TRP CSI are arranged before CSI part2 odd subbands of the NCJT CSI and the s-TRP CSI. The CSI part2 even subbands of the NCJT CSI and the s-TRP CSI may be mapped in the mapping order of multi-TRP CSI and single TRP CSI predefined in the protocol, and the CSI part2 odd subbands of the NCJT CSI and the s-TRP CSI may be mapped in the mapping order of multi-TRP CSI and single TRP CSI predefined in the protocol. For example, refer to Table 6.3.1.1.2-11A in protocol 38.212 (Table 6.3.1.1.2-11A), Table 6.3.1.1.2-11B (Table 6.3.1.1.2-11B), Table 6.3.2.1.2-5A (Table 6.3.2.1.2-5A), Table 6.3.2.1.2-5B (Table 6.3.2.1.2-5B), Table 6.3.2.1.2-5C (Table 6.3.2.1.2-5C), and Table (Table 6.3.2.1.2-5D).

This embodiment is described below by using examples.

If csi-ReportMode of a sub-configuration is mode1, and the value of numberOfSingleTRP-CSI-Mode1 is 2, it means that CSI of the sub-configuration includes three pieces of CSI: one piece of NCJT CSI and two pieces of s-TRP CSI, that is, when the CSI of the sub-configuration includes multiple pieces of CSI, a table of a CSI mapping order in a related protocol needs to be adjusted or annotated to explain how multiple pieces of CSI included in multiple sub-configurations are arranged when the sub-configuration includes NCJT CSI and S-TRP CSI.

Mode 1: In a table of CSI mapping order of the sub-configuration, such as a last row of Table 4, a note is added to indicate that when one sub-configuration includes multiple pieces of CSI, a CSI field of each row in the table is either even subband CSI of multiple pieces of CSI or odd subband CSI of multiple pieces of CSI. Table 4 can be understood as an extension of Table 6.3.1.1.2-11 (Table 6.3.1.1.2-11) in protocol 38.212, and in protocol 38.212, Table 6.3.1.1.2-11 shows a mapping order of CSI part2 in a single csi-ReportConfig. In Table 6.3.1.1.2-11, CQI of all even subbands is mapped first, PMI of all even subbands is mapped, CQI of all odd subbands is mapped, and finally PMI of all odd subbands is mapped. However, because one csi-ReportConfig may include multiple sub-configurations, this embodiment of this application expands each field to include multiple sub-configs on the basis of Table 6.3.1.1.2-11 in protocol 38.212, where each sub-config is arranged based on an Id. CQI of all even subbands of sub-report #1 is arranged first, and then PMI of all even subbands of sub-report #1 is arranged, as shown in CSI field in Table 4 below.

Further, if one sub-configuration includes at least two pieces of CSI, even subband CSI of CSI part2 of the at least two pieces of CSI is mapped in a mapping order of a mapping table of multi-TR(CSI and single TRS CSI predefined in a protocol. For example, the mapping table may be Table 6.3.1.1.2-11A, Table 6.3.1.1.2-11B, Table 6.3.2.1.2-5A, Table 6.3.2.1.2-5B, Table 6.3.2.1.2-5C, and Table 6.3.2.1.2-5D in protocol 38.212.

TABLE 4
Mapping order of a CSI field of a CSI report

| CSI | | |
|---|---|---|
| report | | |
| number | CSI field | Explanation |
| CSI | Subband differential CQI | CSI of even subbands of |
| report #n | for a 2^{nd} TB of all even | three pieces of CSI of |
| Part2 | subbands of sub-report#1 | sub-report#1, and for a |
| subband | (Subband differential CQI | mapping order of multiple |
| | for the second TB of all | pieces of CSI, refer to |
| | even subbands) | reporting orders of NCJT |
| | | and S-TRP CSI in the |
| | | existing protocol |
| | PMI subband information | PMI subband information |
| | fields X₂ of all even | fields X₂ of even subbands |
| | subbands of sub-report#1 | of three pieces of CSI of |
| | (PMI subband information | sub-report#1, and for a |
| | fields X₂ of all even | mapping order of multiple |
| | subbands) | pieces of CSI, refer to |
| | | reporting orders of NCJT |
| | | and S-TRP CSI in the existing |
| | | protocol |
| | . . . | . . . |
| | Subband differential for | Subband differential for a 2^{nd} |
| | a 2^{nd} TB of all even | TB of even subbands of three |
| | subbands of sub-report#n | pieces of CSI of sub-report#n |
| | (Subband differential CQI | is included |
| | for the second TB of all | |
| | even subbands) | |
| | PMI subband information | PMI subband information |
| | fields X₂ of all even | fields X₂ of even subbands |
| | subbands of sub-report#n | of three pieces of CSI of |
| | (PMI subband information | sub-report#n are included |
| | fields X₂ of all even | |
| | subbands) | |
| | Subband differential CQI | Subband differential CQI for |
| | for a 2^{nd} TB of all even | a 2^{nd} TB of odd subbands of |
| | subbands of sub-report#1 | three pieces of CSI of sub- |
| | (Subband differential CQI | report#1 is included |
| | for the second TB of all | |
| | even subbands) | |
| | PMI subband information | PMI subband information |
| | fields X₂ of all even | fields X₂ of odd subbands of |
| | subbands of sub-report#₁ | three pieces of CSI of sub- |
| | (PMI subband information | report#1 are included |
| | fields X₂ of all even | |
| | subbands) | |
| | | . . . |
| | Subband differential CQI | Subband differential CQI for |
| | for a 2^{nd} TB of all even | a 2^{nd} TB of odd subbands of |
| | subbands of sub-report#n | three pieces of CSI of sub- |
| | (Subband differential CQI | report#n is included |
| | for the second TB of all | |
| | even subbands) | |
| | PMI subband information | PMI subband information |
| | fields X₂ of all even | fields X₂ of odd subbands of |
| | subbands of sub-report#n | three pieces of CSI of sub- |
| | (PMI subband information | report#n are included |
| | fields X₂ of all even | |
| | subbands) | |
| Note | If csi-ReportSubConfig | |
| | includes multiple pieces | |
| | of CSI, only an even | |
| | portion of the multiple | |
| | pieces of CSI or an odd | |
| | portion of the multiple | |
| | pieces of CSI is included in | |
| | each field or each row in | |
| | the table of CSI mapping | |
| | (If a csi-ReportSubConfig | |
| | contains more than one CSI, | |
| | only the even portion of | |
| | the multiple pieces of CSI | |
| | or the odd portion of the | |
| | multiple pieces of CSI are | |
| | included in each CSI field | |
| | in each row.) | |

Mode 2: Directly modify the table of CSI mapping order, and use an example in which the CSI reporting mode is mode1, and three pieces of CSI are reported, where the three pieces of CSI are NCJT CSI, s-TRP CSI of a 1^{st} TRP, and s-TRY CSI of a 2^{nd} TRP. An example in which there are two sub-configurations, and each sub-configuration includes three pieces of CSI is used, and a CSI arrangement rule can be shown in Table 5.

TABLE 5

| | | |
|---|---|---|
| Three pieces of subband | PMI of a 1^{st} TRP of NCJT | Field group A |
| CSI of even subbands | PMI of a 2^{nd} TRP of NCJT | |
| of sub-configuration 0 | CQI of a 1^{st} S-TRP | |
| | PMI of a 1^{st} S-TRP | |
| | CQI of a 2^{nd} S-TRP | |
| | PMI of a 2^{nd} S-TRP | |
| Three pieces of subband | PMI of a 1^{st} TRP of NCJT | Field group A |
| CSI of even subbands | PMI of a 2^{nd} TRP of NCJT | |
| of sub-configuration 1 | CQI of a 1^{st} S-TRP | |
| | PMI of a 1^{st} S-TRP | |
| | CQI of a 2^{nd} S-TRP | |
| | PMI of a 2^{nd} S-TRP | |
| Three pieces of subband | PMI of a 1^{st} TRP of NCJT | Field group B |
| CSI of odd subbands | PMI of a 2^{nd} TRP of NCJT | |
| of sub-configuration 0 | CQI of a 1^{st} S-TRP | |
| | PMI of a 1^{st} S-TRP | |
| | CQI of a 2^{nd} S-TRP | |
| | PMI of a 2^{nd} S-TRP | |
| Three pieces of subband | PMI of a 1^{st} TRP of NCJT | Field group B |
| CSI of odd subbands | PMI of a 2^{nd} TRP of NCJT | |
| of sub-configuration 1 | CQI of a 1^{st} S-TRP | |
| | PMI of a 1^{st} S-TRP | |
| | CQI of a 2^{nd} S-TRP | |
| | PMI of a 2^{nd} S-TRP | |

Field group A is an even subband portion in a table of NCJT part2 subband CSI mapping in the existing protocol (such as Table 6.3.1.1.2-11A, Table 6.3.1.1.2-11B, Table 6.3.2.1.2-5A, Table 6.3.2.1.2-5B, Table 6.3.2.1.2-5C, and Table 6.3.2.1.2-5D in protocol 38.212), and Field group B is an odd subband portion in a table of NCJT part2 subband CSI mapping in the existing protocol, where Table 5 is described by using Table 6.3.1.1.2-11A as an example.

In this example, Table 6.3.11.2-11A is only used as an example, where six rows of Field group A correspond to a 1^{st} row to a 6^{th} row of Table 6.3.1.1.2-11A, and six rows of Field group B correspond to a 7^{th} row to a 12^{th} row of Table 6.3.1.1.2-11A. If Table 6.3.11.2-11B is used as an example again, Field group A is a 1^{st} row, a 2^{nd} row, a 5^{th} row, and a 6^{th} row of Table 6.3.11.2-11B, and Field group B is a 3^{rd} row, a 4^{th} row, a 7^{th} row, and an 8^{th} row of Table 6.3.11.2-11B; if Table 6.3.11.2-5C is used as an example again, Field group A is first six rows of Table 6.3.11.2-5C, and Field group B is last six rows of Table 6.3.11.2-5C; and if Table 6.3.11.2-5D is used as an example again, Field group A is a 1^{st} row, a 2^{nd} row, a 5^{th} row, and a 6^{th} row of Table 6.3.11.2-5D, and Field group B is a 3^{rd} row, a 4^{th} row, a 7^{th} row, and an 8^{th} row of Table 6.3.11.2-5C.

Based on this example, when a sub-configuration includes NCJT CSI and S-TRP CSI, how to arrange multiple pieces of CSI included in CSI of multiple sub-configurations may be deduced.

In conclusion, it can be learned that in this embodiment of this application, when there are multiple sub-configurations, and each sub-configuration includes multiple pieces of CSI (at least including NCJT CSI and S-TRP CSI), a mapping order of CSI part2 subband can be:
arrange even subband CSI of all pieces of CSI included in all sub-configurations, and then arrange odd subband CSI of all pieces of CSI included in all the sub-configurations, where
sub-configurations are mapped one-to-one in ascending order of identifiers of the sub-configurations; and
for a mapping order of multiple pieces of CSI included in the sub-configuration, refer to Table of the existing protocol, such as Table 6.3.1.1.2-11A, Table 6.3.1.1.2-11B, Table 6.3.2.1.2-5A, Table 6.3.2.1.2-5B, Table 6.3.2.1.2-5C, and Table 6.3.2.1.2-5D in protocol 38.212.

It should be further noted that in the related protocol, related description of NCJT CSI reporting involves K1 (namely, a number of resources in resource group1 in csi-ReportConfig), K2 (namely, a number of resources in resource group2 in csi-ReportConfig), and N (namely, a number of CMR pairs in csi-ReportConfig). In this embodiment, each sub-configuration can be regarded as an independent CSI report. When calculating NCJT CSI report of the sub-configuration, especially CSI report of the sub-configuration of Type II shutdown, it needs to clarify how K1, K2, and N described in the protocol correspond to the sub-configuration.

If m-TRP performs Type II shutdown, that is, the sub-configuration includes one NZP-CSI-RS ResourceList, the NZP-CSI-RS ResourceList includes

$${K}_{S}^{l}$$

resources, and K3 resources in these

$${K}_{S}^{l}$$

resources are subsets of group1 associated with csi-ReportConfig. In another part, K4 resources are subsets of group2 associated with csi-ReportConfig, so for NCJT CSI report of the sub-configuration, K3 corresponds to K1 in the protocol, and K4 corresponds to K2 in the protocol.

The UE determines, based on a relationship of CMR pairing in csi-ReportConfig, how many resource pairs there are in the sub-configuration, so for CSI report of the sub-configuration, a number of CMR pairs associated with the sub-configuration corresponds to N in the protocol.

Optionally, when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

In this embodiment, to ensure that a resource set associated with the CSI report configuration is a complete set of resources associated with the sub-configuration, there may be a large number of resources associated with the CSI report configuration, and there may be a large number of ports of each resource (because the sub-configuration configures port-SubsetIndicator based on the resources of the CSI report configuration), which may inevitably exceed a limit on the existing number of resources and a limit on the existing number of ports. Therefore, the limit on the number of resources and the limit on the number of ports in the resource set in the existing protocol are applied to each sub-configuration, that is, in each sub-configuration, a number of resources associated with each sub-configuration and a number of ports of each resource should meet limits in the existing protocol. That is, when a number of CSI-RS resources associated with the sub-configuration is 1, a maximum number of ports supported by each resource associated with the sub-configuration is 32; when a number of CSI-RS resources associated with the sub-configuration is 2, a maximum number of ports supported by each resource associated with the sub-configuration is 16; and when a number of CSI-RS resources associated with the sub-configuration is greater than 2 and less than or equal to 8, a maximum number of ports supported by each resource associated with the sub-configuration is 8.

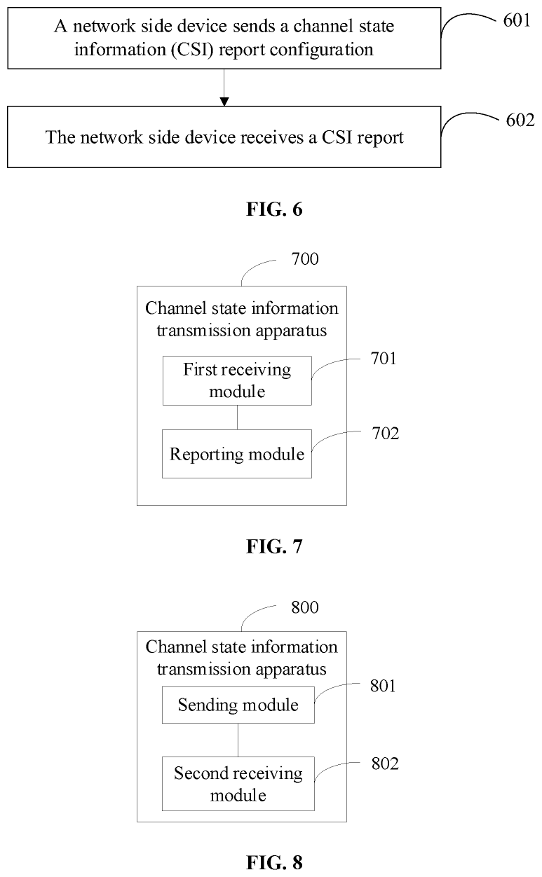

Referring to FIG. 6, FIG. 6 is a flowchart of a channel state information transmission method according to an embodiment of this application. The method may be performed by a network side device. As shown in FIG. 6, the method includes the following steps.

Step 601: A network side device sends a channel state information (CSI) report configuration.

Step 602: The network side device receives a CSI report.

Resources associated with the CSI report configuration are configured as N resource groups, the CSI report configuration is associated with at least one sub-configuration, and the CSI report includes CSI of the at least one sub-configuration; or the network side device prohibits configuring the CSI report configuration to be associated with at least one sub-configuration when resources associated with the CSI report configuration are configured as N resource groups; or the network side device prohibits configuring resources associated with the CSI report configuration as N resource groups when the CSI report configuration is associated with at least one sub-configuration; and N is an integer greater than or equal to 2.

Optionally, the sub-configuration includes at least one of the following:
a first identifier, indicating a resource group associated with the sub-configuration;
a second identifier, indicating a transmission reception point (TRP) associated with the sub-configuration;
a port subset indicator;
a code book subset restriction (CBSR);
a rank indicator (RI) restriction;
at least one list of channel state information reference signal (CSI-RS) resources;
a power offset value;
channel measurement resource (CMR) pair configuration information;
a CSI report mode; and
a number of pieces of single TRP CSI reported when the CSI report mode is a first mode.

Optionally, the first identifier includes a bitmap for indicating the resource group associated with the sub-configuration;
or
the first identifier includes a resource group identifier of the resource group associated with the sub-configuration.

Optionally, the sub-configuration includes N groups of CSI-RS resources, each group of CSI-RS resources includes at least one CSI-RS resource of one of N resource groups associated with the CSI report configuration, and the N groups of CSI-RS resources correspond to the N resource groups respectively;
or
the sub-configuration includes one group of CSI-RS resources, and a number of resources of the group of CSI-RS resources is the same as a number of the resources associated with the CSI report configuration;
or
the sub-configuration includes one group of CSI-RS resources, and the group of CSI-RS resources includes at least one resource of each of the N resource groups.

Optionally, the CMR pair configuration information includes CMR pairing information; or the CMR pair configuration information includes an identifier of a CMR pair; or the CMR pair configuration information includes a sequence number of a CMR pair in all CMR pairs configured in the CSI report configuration.

Optionally, when the sub-configuration includes the CMR pair configuration information, and the sub-configuration does not include the at least one group of CSI-RS resources, the CMR pair configured by the CMR pair configuration includes resources from different resource groups in the resources associated with the CSI report configuration associated with the sub-configuration;
or
when the sub-configuration includes the CMR pair configuration information, and the sub-configuration includes the N groups of CSI-RS resources, the CMR pair configured by the CMR pair configuration includes resources from two groups of CSI-RS resources in the N groups of CSI-RS resources;
or
when the sub-configuration includes the CMR pair configuration information, and the sub-configuration includes one group of CSI-RS resources, the CMR pair configured by the CMR pair configuration includes resources from different resource groups in the one group of CSI-RS resources.

Optionally, when the CSI report includes CSI of at least two sub-configurations, the CSI of the at least two sub-configurations is mapped in ascending order of identifiers of the at least two sub-configurations.

Optionally, CSI part1 of the CSI report includes at least two sub-configuration CSIs' CSI part1, and the at least two sub-configuration CSIs' CSI part1 is mapped in ascending order of the identifiers of the at least two sub-configurations.

Optionally, a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and

a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations.

Optionally, when the CSI of the sub-configuration includes at least two pieces of CSI, a mapping order of even subband CSI of CSI part2 of the at least two pieces of CSI is before a mapping order of odd subband CSI of CSI part2 of the at least two pieces of CSI, where
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol.

Optionally, when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

It should be noted that for an implementation of the embodiment, refer to related description in the embodiment shown in FIG. 5. Details are not described herein again.

It should be noted that, the channel state information transmission method provided in this embodiment of this application may be performed by a channel state information transmission apparatus, or by a control module that is in the channel state information transmission apparatus and that is configured to perform the channel state information transmission method. In this embodiment of this application, that the channel state information transmission apparatus performs the channel state information transmission method is used as an example to describe the channel state information transmission apparatus provided in this embodiment of this application.

Referring to FIG. 7, FIG. 7 is a structural diagram of a channel state information transmission apparatus according to an embodiment of this application. As shown in FIG. 7, the channel state information transmission apparatus 700 includes:
a first receiving module 701, configured to receive a channel state information (CSI) report configuration; and
a reporting module 702, configured to report a CSI report based on the CSI report configuration, where
resources associated with the CSI report configuration are configured as N resource groups, the CSI report configuration is associated with at least one sub-configuration, and the CSI report includes CSI of the at least one sub-configuration; or a terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

Optionally, the sub-configuration includes at least one of the following:
a first identifier, indicating a resource group associated with the sub-configuration;
a second identifier, indicating a transmission reception point (TRP) associated with the sub-configuration;
a port subset indicator;
a code book subset restriction (CBSR);
a rank indicator (RI) restriction;
at least one list of channel state information reference signal (CSI-RS) resources;
a power offset value;
channel measurement resource (CMR) pair configuration information;
a CSI report mode; and
a number of pieces of single TRP CSI reported when the CSI report mode is a first mode.

Optionally, the first identifier includes a bitmap for indicating the resource group associated with the sub-configuration;
or
the first identifier includes a resource group identifier of the resource group associated with the sub-configuration.

Optionally, the sub-configuration includes N groups of CSI-RS resources, each group of CSI-RS resources includes at least one CSI-RS resource of one of N resource groups associated with the CSI report configuration, and the N groups of CSI-RS resources correspond to the N resource groups respectively;
or
the sub-configuration includes one group of CSI-RS resources, and a number of resources of the group of CSI-RS resources is the same as a number of the resources associated with the CSI report configuration;
or
the sub-configuration includes one group of CSI-RS resources, and the group of CSI-RS resources includes at least one resource of each of the N resource groups.

Optionally, the CMR pair configuration information includes CMR pairing information; or the CMR pair configuration information includes an identifier of a CMR pair; or the CMR pair configuration information includes a sequence number of a CMR pair in all CMR pairs configured in the CSI report configuration.

Optionally, when the sub-configuration includes the CMR pair configuration information, and the sub-configuration does not include the at least one group of CSI-RS resources, the CMR pair configured by the CMR pair configuration includes resources from different resource groups in the resources associated with the CSI report configuration associated with the sub-configuration;
or
when the sub-configuration includes the CMR pair configuration information, and the sub-configuration includes the N groups of CSI-RS resources, the CMR pair configured by the CMR pair configuration includes resources from two groups of CSI-RS resources in the N groups of CSI-RS resources;
or
when the sub-configuration includes the CMR pair configuration information, and the sub-configuration includes one group of CSI-RS resources, the CMR pair configured by the CMR pair configuration includes resources from different resource groups in the one group of CSI-RS resources.

Optionally, the apparatus further includes a calculation module, configured to:
when the sub-configuration includes a port subset indicator, a CBSR, an RI restriction, and a power offset value, calculate the CSI of the sub-configuration based on that a port state of all CSI-RS resources associated with the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value for each resource associated with the CSI report configuration is increased or decreased by the power offset value included in the sub-configuration;
or
when the sub-configuration includes at least one group of CSI-RS resources and a power offset value, calculate the CSI of the sub-configuration based on that the at least one group of CSI-RS resources included in the sub-configuration is used as a measurement resource, and a power control offset value of each resource of the at least one group of CSI-RS resources included in the sub-configuration is increased or decreased by the power offset value included in the sub-configuration;
or
when the sub-configuration includes a port subset indicator, a CBSR, an RI restriction, at least one group of CSI-RS resources, and a power offset value, calculate the CSI of the sub-configuration based on that the at least one group of CSI-RS resources included in the sub-configuration is used as a measurement resource, a port state of the at least one group of CSI-RS resources included in the sub-configuration is a port state indicated by the port subset indicator, an RI restriction for CSI calculation of the sub-configuration is the RI restriction included in the sub-configuration, a CBSR for CSI calculation of the sub-configuration is the CBSR included in the sub-configuration, and a power control offset value of each resource of the at least one group of CSI-RS resources included in the sub-configuration is increased or decreased by the power offset value included in the sub-configuration;
or
when the sub-configuration includes a port subset indicator, a CBSR, an RI restriction, at least one group of CSI-RS resources, and a power offset value, perform at least one of the following:
calculating single TRP CSI of a first resource group based on that a port state of a resource of a first resource group is a port state indicated by the port subset indicator, an RI restriction for single TRP CSI calculation of the first resource group is the RI restriction included in the sub-configuration, a CBSR for single TRP CSI calculation of the first resource group is the CBSR included in the sub-configuration, and a power control offset value of each resource of the first resource group is increased or decreased by the power offset value included in the sub-configuration;
calculating single TRP CSI of a second resource group based on that a resource of the at least one group of CSI-RS resources is used as a measurement resource of single TRP CSI of a second resource group, and a power control offset value of each resource of the at least one group of CSI-RS resources is increased or decreased by the power offset value included in the sub-configuration; and
calculating, based on that a port state of a resource of a first resource group is a port state indicated by the port subset indicator, a resource of the at least one group of CSI-RS resources is used as a measurement resource of a second resource group, an RI restriction for multi-TRP CSI calculation is the RI restriction included in the sub-configuration or an RI restriction included in the CSI report configuration, a CBSR for multi-TRP CSI calculation is the CBSR included in the sub-configuration or a CBSR included in the CSI report configuration, and a power control offset value of each resource of the first resource group and a power control offset value of each resource of the at least one group of CSI-RS resources are increased or decreased by the power offset value included in the sub-configuration, the multi-TRP CSI, where
the first resource group and the second resource group are different resource groups of the N resource groups;
or
when the sub-configuration does not include the CMR pair configuration information, calculate multi-TRP CSI of the sub-configuration based on CMR pair configuration information in a resource setting associated with the CSI report configuration;
or
when the sub-configuration includes the CMR pair configuration information, calculate the multi-TRP CSI of the sub-configuration based on the CMR pair configuration information included in the sub-configuration.

Optionally, the apparatus further includes a first determining module, configured to:
when the sub-configuration includes the CSI report mode or the number of pieces of single TRP CSI reported when the CSI report mode is the first mode, determine, based on the CSI report mode or the number of pieces of single TRP CSI reported when the CSI report mode is the first mode included in the sub-configuration, CSI that needs to be reported by the sub-configuration;
or
when the sub-configuration does not include the CSI report mode or the number of pieces of single TRP CSI reported when the CSI report mode is the first mode, determine, based on a CSI report mode configured by the CSI report configuration or the number of pieces of single TRP CSI reported in the first mode, CSI that needs to be reported by the sub-configuration;
or
when the sub-configuration does not include the CSI report mode or the number of pieces of single TRP CSI reported in the first mode, determine, based on the first identifier, CSI that needs to be reported by the sub-configuration, where when the first identifier indicates one resource group, the CSI that needs to be reported by the sub-configuration includes single TRP CSI corresponding to the resource group indicated by the first identifier, and when the first identifier indicates at least two resource groups, the CSI that needs to be reported by the sub-configuration includes multi-TRP CSI corresponding to the at least two resource groups indicated by the first identifier.

Optionally, the apparatus further includes:

a second determining module, configured to: when the sub-configuration includes the first identifier, determine, based on the first identifier, the resource group associated with the sub-configuration.

Optionally, when the CSI report includes CSI of at least two sub-configurations, the CSI of the at least two sub-configurations is mapped in ascending order of identifiers of the at least two sub-configurations.

Optionally, CSI part1 of the CSI report includes at least two sub-configuration CSIs' CSI part1, and the at least two sub-configuration CSIs' CSI part1 is mapped in ascending order of the identifiers of the at least two sub-configurations.

Optionally, a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and

a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations.

Optionally, the CSI report configuration is associated with at least two sub-configurations, and the apparatus further includes:
a discarding module, configured to omit or discard a part or all of CSI part2 of the at least two sub-configurations based on a mapping order of CSI part2 of the at least two sub-configurations, where
the mapping order of CSI part2 of the at least two sub-configurations is determined based on an order of the identifiers of the at least two sub-configurations.

Optionally, when the CSI of the sub-configuration includes at least two pieces of CSI, a mapping order of even subband CSI of CSI part2 of the at least two pieces of CSI is before a mapping order of odd subband CSI of CSI part2 of the at least two pieces of CSI, where
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol.

Optionally, when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

The channel state information transmission apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a network attached storage (NAS), or the like. This is not specifically limited in this embodiment of this application.

The channel state information transmission apparatus provided in this embodiment of this application can implement the processes implemented in the method embodiment in FIG. 5, and achieve a same technical effect. To avoid repetition, details are not described herein again.

Referring to FIG. 8, FIG. 8 is a structural diagram of a channel state information transmission apparatus according to an embodiment of this application. As shown in FIG. 8, the channel state information transmission apparatus 800 includes:
a sending module 801, configured to send a channel state information (CSI) report configuration; and
a second receiving module 802, configured to receive a CSI report, where
resources associated with the CSI report configuration are configured as at least two resource groups, the CSI report configuration is associated with at least one sub-configuration, and the CSI report includes CSI of the at least one sub-configuration; or a network side device prohibits configuring the CSI report configuration to be associated with at least one sub-configuration when resources associated with the CSI report configuration are configured as at least two resource groups; or the network side device prohibits configuring resources associated with the CSI report configuration as at least two resource groups when the CSI report configuration is associated with at least one sub-configuration.

Optionally, the sub-configuration includes at least one of the following:
a first identifier, indicating a resource group associated with the sub-configuration;
a second identifier, indicating a transmission reception point (TRP) associated with the sub-configuration;
a port subset indicator;
a code book subset restriction (CBSR);
a rank indicator (RI) restriction;
at least one list of channel state information reference signal (CSI-RS) resources;
a power offset value;
channel measurement resource (CMR) pair configuration information;
a CSI report mode; and
a number of pieces of single TRP CSI reported when the CSI report mode is a first mode.

Optionally, the first identifier includes a bitmap for indicating the resource group associated with the sub-configuration;
or
the first identifier includes a resource group identifier of the resource group associated with the sub-configuration.

Optionally, the sub-configuration includes N groups of CSI-RS resources, each group of CSI-RS resources includes at least one CSI-RS resource of one of N resource groups associated with the CSI report configuration, and the N groups of CSI-RS resources correspond to the N resource groups respectively;
or
the sub-configuration includes one group of CSI-RS resources, and a number of resources of the group of CSI-RS resources is the same as a number of the resources associated with the CSI report configuration;
or
the sub-configuration includes one group of CSI-RS resources, and the group of CSI-RS resources includes at least one resource of each of the N resource groups.

Optionally, the CMR pair configuration information includes CMR pairing information; or the CMR pair configuration information includes an identifier of a CMR pair; or the CMR pair configuration information includes a sequence number of a CMR pair in all CMR pairs configured in the CSI report configuration.

Optionally, when the sub-configuration includes the CMR pair configuration information, and the sub-configuration does not include the at least one group of CSI-RS resources, the CMR pair configured by the CMR pair configuration includes resources from different resource groups in the resources associated with the CSI report configuration associated with the sub-configuration;
or
when the sub-configuration includes the CMR pair configuration information, and the sub-configuration includes the N groups of CSI-RS resources, the CMR pair configured by the CMR pair configuration includes resources from two groups of CSI-RS resources in the N groups of CSI-RS resources;
or
when the sub-configuration includes the CMR pair configuration information, and the sub-configuration includes one group of CSI-RS resources, the CMR pair configured by the CMR pair configuration includes resources from different resource groups in the one group of CSI-RS resources.

Optionally, when the CSI report includes CSI of at least two sub-configurations, the CSI of the at least two sub-configurations is mapped in ascending order of identifiers of the at least two sub-configurations.

Optionally, CSI part1 of the CSI report includes at least two sub-configuration CSIs' CSI part1, and the at least two sub-configuration CSIs' CSI part1 is mapped in ascending order of the identifiers of the at least two sub-configurations.

Optionally, a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and
a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations.

Optionally, when the CSI of the sub-configuration includes at least two pieces of CSI, a mapping order of even subband CSI of CSI part2 of the at least two pieces of CSI is before a mapping order of odd subband CSI of CSI part2 of the at least two pieces of CSI, where
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol.

Optionally, when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

The channel state information transmission apparatus in this embodiment of this application may be an electronic device, for example, an electronic device with an operating system, or may be a component in the electronic device, for example, an integrated circuit or a chip. The electronic device may be a network side device, or another device other than the network side device. For example, the network side device may include but is not limited to the foregoing listed types of the network side device 12. The another device may be a server, a network attached storage (NAS), and the like. This is not specifically limited in this embodiment of this application.

The channel state information transmission apparatus provided in this embodiment of this application can implement the processes implemented in the method embodiment in FIG. 6, and achieve a same technical effect. To avoid repetition, details are not described herein again.

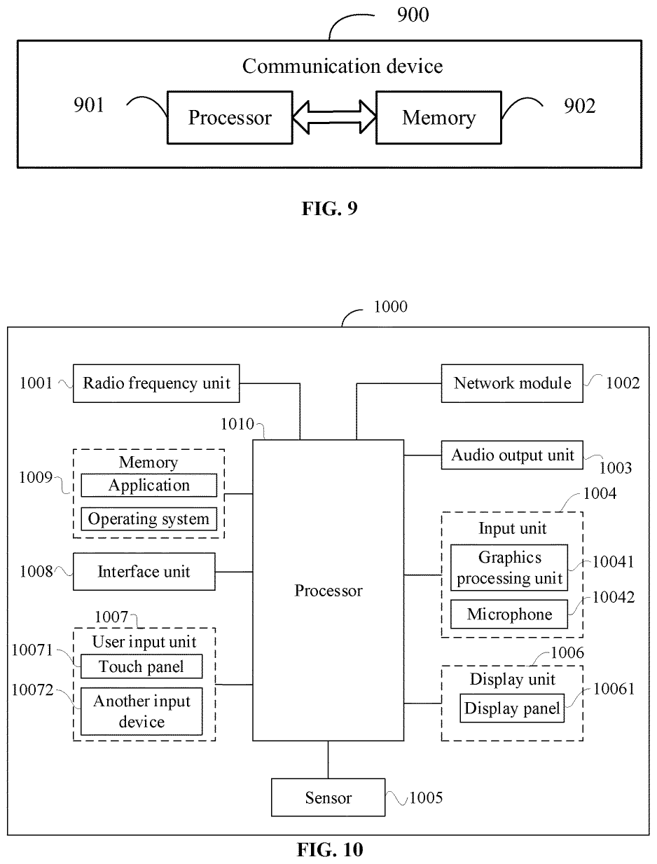

Optionally, as shown in FIG. 9, an embodiment of this application further provides a communication device 900, including a processor 901 and a memory 902. The memory 902 stores a program or an instruction that can be run on the processor 901. For example, when the communication device 900 is a terminal, the program or the instruction is executed by the processor 901 to implement the steps of the embodiment of the channel state information transmission method, and a same technical effect can be achieved. When the communication device 900 is a network side device, when the program or the instruction is executed by the processor 901, the steps of the embodiment of the channel state information transmission method are implemented, and a same technical effect can be achieved. To avoid repetition, details are not described herein again.

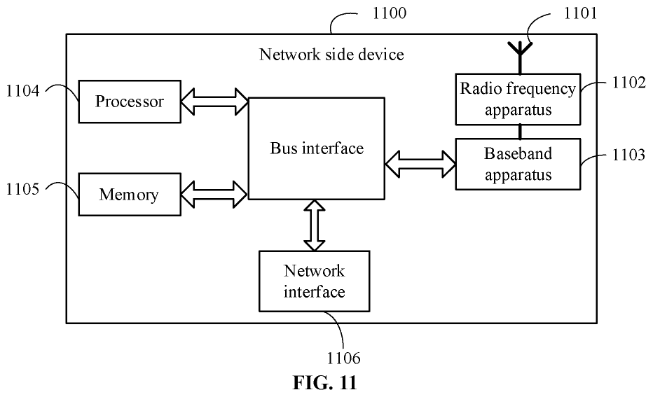

An embodiment of this application further provides a terminal, including a processor and a communication interface, where the communication interface is configured to: receive a channel state information (CSI) report configuration; and report a CSI report based on the CSI report configuration, where resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2. The terminal embodiment is corresponding to the method embodiment on the terminal side, each implementation process and implementation of the method embodiment can be applied to the terminal embodiment, and a same technical effect can be achieved. Specifically, FIG. 10 is a schematic diagram of a hardware structure of a terminal according to an embodiment of this application.

The terminal 1000 includes but is not limited to at least a part of components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 10 constitutes no limitation on the terminal, and the terminal may include more or fewer components than those shown in the figure, or combine some components, or have different component arrangements. Details are not described herein.

It should be understood that in this embodiment of this application, the input unit 1004 may include a graphics processing unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1001 may transmit the downlink data to the processor 1010 for processing. In addition, the radio frequency unit 1001 may send uplink data to the network side device. Generally, the radio frequency unit 1001 includes but is not limited to an antenna, an amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may include a volatile memory or a non-volatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1009 in this embodiment of this application includes but is not limited to these memories and any memory of another proper type.

The processor 1010 may include one or more processing units. Optionally, an application processor and a modem processor are integrated into the processor 1010. The application processor mainly processes an operating system, a user interface, an application, or the like. The modem processor mainly processes a wireless communication signal, for example, a baseband processor. It can be understood that, alternatively, the modem processor may not be integrated into the processor 1010.

The radio frequency unit 1001 is configured to receive a channel state information (CSI) report configuration; and

the radio frequency unit 1001 is further configured to report a CSI report based on the CSI report configuration, where resources associated with the CSI report configuration are configured as N resource groups, the CSI report configuration is associated with at least one sub-configuration, and the CSI report includes CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

It can be understood that for the implementation process of each implementation given in this embodiment, refer to the related description of the method embodiment, and a same or corresponding technical effect is achieved. To avoid repetition, details are not described herein again.

An embodiment of this application further provides a network side device, including a processor and a communication interface, where the communication interface is configured to send a channel state information (CSI) report configuration; and the communication interface is further configured to receive a CSI report, where resources associated with the CSI report configuration are configured as N resource groups, the CSI report configuration is associated with at least one sub-configuration, and the CSI report includes CSI of the at least one sub-configuration; or the network side device prohibits configuring the CSI report configuration to be associated with at least one sub-configuration when resources associated with the CSI report configuration are configured as N resource groups; or the network side device prohibits configuring resources associated with the CSI report configuration as N resource groups when the CSI report configuration is associated with at least one sub-configuration; and N is an integer greater than or equal to 2. This network side device embodiment is corresponding to the foregoing method embodiment of the network side device. Each implementation process and implementation of the foregoing method embodiment may be applicable to this network side device embodiment, and a same technical effect can be achieved.

Specifically, an embodiment of this application further provides a network side device. As shown in FIG. 11, the network side device 1100 includes an antenna 1101, a radio frequency apparatus 1102, a baseband apparatus 1103, a processor 1104, and a memory 1105. The antenna 1101 is connected to the radio frequency apparatus 1102. In an uplink direction, the radio frequency apparatus 1102 receives information through the antenna 1101, and sends the received information to the baseband apparatus 1103 for processing. In a downlink direction, the baseband apparatus 1103 processes information that needs to be sent, and sends processed information to the radio frequency apparatus 1102. The radio frequency apparatus 1102 processes the received information, and sends processed information through the antenna 1101.

In the foregoing embodiment, the method performed by the network side device may be implemented in the baseband apparatus 1103. The baseband apparatus 1103 includes a baseband processor.

For example, the baseband apparatus 1103 may include at least one baseband board. A plurality of chips are disposed on the baseband board. As shown in FIG. 11, one chip is, for example, a baseband processor, and is connected to the memory 1105 by using a bus interface, to invoke a program in the memory 1105 to perform the operations of the network device shown in the foregoing method embodiment.

The network side device may further include a network interface 1106, and the interface is, for example, a common public radio interface (CPRI).

Specifically, the network side device 1100 in this embodiment of this application further includes an instruction or a program that is stored in the memory 1105 and that can be run on the processor 1104. The processor 1104 invokes the instruction or the program in the memory 1105 to perform the method performed by the modules shown in FIG. 8, and a same technical effect is achieved. To avoid repetition, details are not described herein again.

An embodiment of this application further provides a readable storage medium. The readable storage medium stores a program or an instruction, and when the program or the instruction is executed by a processor, the processes of the channel state information transmission method embodiment are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the channel state information transmission method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the channel state information transmission method embodiment, and a same technical effect can be achieved. To avoid repetition, details are not described herein again.

An embodiment of this application further provides a channel state information transmission system, including a terminal and a network side device. The terminal is configured to execute the processes in FIG. 6 and the foregoing method embodiments, the network side device is configured to execute the processes in FIG. 5 and the foregoing method embodiments, and a same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. A channel state information transmission method, comprising:
receiving, by a terminal, a channel state information (CSI) report configuration; and
reporting, by the terminal, a CSI report based on the CSI report configuration, wherein
resources associated with the CSI report configuration are configured as N resource groups, the CSI report configuration is associated with at least one sub-configuration, and the CSI report comprises CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

2. The method according to claim 1, wherein the sub-configuration comprises at least one of the following:
a first identifier, indicating a resource group associated with the sub-configuration;
a second identifier, indicating a transmission reception point (TRP) associated with the sub-configuration;
a port subset indicator;
a code book subset restriction (CBSR);
a rank indicator (RI) restriction;
at least one group of channel state information reference signal (CSI-RS) resources;
a power offset value;
channel measurement resource (CMR) pair configuration information;
a CSI report mode; or
a number of pieces of single TRP CSI reported when the CSI report mode is a first mode.

3. The method according to claim 2, wherein the first identifier comprises a bitmap for indicating the resource group associated with the sub-configuration;
or
the first identifier comprises a resource group identifier of the resource group associated with the sub-configuration.

4. The method according to claim 2, wherein the sub-configuration comprises N groups of CSI-RS resources, each group of CSI-RS resources comprises at least one CSI-RS resource of one of N resource groups associated with the CSI report configuration, and the N groups of CSI-RS resources correspond to the N resource groups respectively;
or
the sub-configuration comprises one group of CSI-RS resources, and a number of resources of the group of CSI-RS resources is the same as a number of the resources associated with the CSI report configuration;
or
the sub-configuration comprises one group of CSI-RS resources, and the group of CSI-RS resources comprises at least one resource of each of the N resource groups.

5. The method according to claim 2, wherein the CMR pair configuration information comprises CMR pairing information; or the CMR pair configuration information comprises an identifier of a CMR pair; or the CMR pair configuration information comprises a sequence number of a CMR pair in all CMR pairs configured in the CSI report configuration; and/or,
wherein
when the sub-configuration comprises the CMR pair configuration information, and the sub-configuration does not comprise the at least one group of CSI-RS resources, the CMR pair configured by the CMR pair configuration comprises resources from different resource groups in the resources associated with the CSI report configuration associated with the sub-configuration;
or
when the sub-configuration comprises the CMR pair configuration information, and the sub-configuration comprises the N groups of CSI-RS resources, the CMR pair configured by the CMR pair configuration comprises resources from two groups of CSI-RS resources in the N groups of CSI-RS resources;
or
when the sub-configuration comprises the CMR pair configuration information, and the sub-configuration comprises one group of CSI-RS resources, the CMR pair configured by the CMR pair configuration comprises resources from different resource groups in the one group of CSI-RS resources.

6. The method according to claim 2, wherein before the reporting, by the terminal, a CSI report based on the CSI report configuration, the method further comprises:
when the sub-configuration comprises a port subset indicator, a CBSR, an RI restriction, and a power offset value, calculating, by the terminal, the CSI of the sub-configuration based on that a port state of all CSI-RS resources associated with the sub-configuration is a port state indicated by the port subset indicator, an RI restriction for CSI calculation of the sub-configuration is the RI restriction comprised in the sub-configuration, a CBSR for CSI calculation of the sub-configuration is the CBSR comprised in the sub-configuration, and a power control offset value for each resource associated with the CSI report configuration is increased or decreased by the power offset value comprised in the sub-configuration;
or
when the sub-configuration comprises at least one group of CSI-RS resources and a power offset value, calculating, by the terminal, the CSI of the sub-configuration based on that the at least one group of CSI-RS resources comprised in the sub-configuration is used as a measurement resource, and a power control offset value of each resource of the at least one group of CSI-RS resources comprised in the sub-configuration is increased or decreased by the power offset value comprised in the sub-configuration;
or
when the sub-configuration comprises a port subset indicator, a CBSR, an RI restriction, at least one group of CSI-RS resources, and a power offset value, calculating, by the terminal, the CSI of the sub-configuration based on that the at least one group of CSI-RS resources comprised in the sub-configuration is used as a measurement resource, a port state of the at least one group of CSI-RS resources comprised in the sub-configuration is a port state indicated by the port subset indicator, an RI restriction for CSI calculation of the sub-configuration is the RI restriction comprised in the sub-configuration, a CBSR for CSI calculation of the sub-configuration is the CBSR comprised in the sub-configuration, and a power control offset value of each resource of the at least one group of CSI-RS resources comprised in the sub-configuration is increased or decreased by the power offset value comprised in the sub-configuration;
or
when the sub-configuration comprises a port subset indicator, a CBSR, an RI restriction, at least one group of CSI-RS resources, and a power offset value, performing, by the terminal, at least one of the following:
calculating single TRP CSI of a first resource group based on that a port state of a resource of a first resource group is a port state indicated by the port subset indicator, an RI restriction for single TRP CSI calculation of the first resource group is the RI restriction comprised in the sub-configuration, a CBSR for single TRP CSI calculation of the first resource group is the CBSR comprised in the sub-configuration, and a power control offset value of each resource of the first resource group is increased or decreased by the power offset value comprised in the sub-configuration;
calculating single TRP CSI of a second resource group based on that a resource of the at least one group of CSI-RS resources is used as a measurement resource of single TRP CSI of a second resource group, and a power control offset value of each resource of the at least one group of CSI-RS resources is increased or decreased by the power offset value comprised in the sub-configuration; or
calculating, based on that a port state of a resource of a first resource group is a port state indicated by the port subset indicator, a resource of the at least one group of CSI-RS resources is used as a measurement resource of a second resource group, an RI restriction for multi-TRP CSI calculation is the RI restriction comprised in the sub-configuration or an RI restriction comprised in the CSI report configuration, a CBSR for multi-TRP CSI calculation is the CBSR comprised in the sub-configuration or a CBSR comprised in the CSI report configuration, and a power control offset value of each resource of the first resource group and a power control offset value of each resource of the at least one group of CSI-RS resources are increased or decreased by the power offset value comprised in the sub-configuration, the multi-TRP CSI, wherein
the first resource group and the second resource group are different resource groups of the N resource groups;
or
when the sub-configuration does not comprise the CMR pair configuration information, calculating, by the terminal, multi-TRP CSI of the sub-configuration based on CMR pair configuration information in a resource setting associated with the CSI report configuration;
or
when the sub-configuration comprises the CMR pair configuration information, calculating, by the terminal, multi-TRP CSI of the sub-configuration based on the CMR pair configuration information comprised in the sub-configuration.

7. The method according to claim 2, wherein before the reporting, by the terminal, a CSI report based on the CSI report configuration, the method further comprises:
when the sub-configuration comprises the CSI report mode or the number of pieces of single TRP CSI reported when the CSI report mode is the first mode, determining, by the terminal based on the CSI report mode or the number of pieces of single TRP CSI reported when the CSI report mode is the first mode comprised in the sub-configuration, CSI that needs to be reported by the sub-configuration;
or
when the sub-configuration does not comprise the CSI report mode or the number of pieces of single TRP CSI reported when the CSI report mode is the first mode, determining, by the terminal based on a CSI report mode configured by the CSI report configuration or the number of pieces of single TRP CSI reported in the first mode, CSI that needs to be reported by the sub-configuration;
or
when the sub-configuration does not comprise the CSI report mode or the number of pieces of single TRP CSI reported in the first mode, determining, by the terminal based on the first identifier, CSI that needs to be reported by the sub-configuration, wherein when the first identifier indicates one resource group, the CSI that needs to be reported by the sub-configuration comprises single TRP CSI corresponding to the resource group indicated by the first identifier, and when the first identifier indicates at least two resource groups, the CSI that needs to be reported by the sub-configuration comprises multi-TRP CSI corresponding to the at least two resource groups indicated by the first identifier; and/or,
wherein the method further comprises:
when the sub-configuration comprises the first identifier, determining, by the terminal based on the first identifier, the resource group associated with the sub-configuration.

8. The method according to claim 1, wherein when the CSI report comprises CSI of at least two sub-configurations, the CSI of the at least two sub-configurations is mapped in ascending order of identifiers of the at least two sub-configurations;
wherein CSI part1 of the CSI report comprises at least two sub-configuration CSIs' CSI part1, and the at least two sub-configuration CSIs' CSI part1 is mapped in ascending order of the identifiers of the at least two sub-configurations.

9. The method according to claim 8, wherein a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and
a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations;
wherein the CSI report configuration is associated with at least two sub-configurations, and the method further comprises:
omitting or discarding, by the terminal, a part or all of CSI part2 of the at least two sub-configurations based on a mapping order of CSI part2 of the at least two sub-configurations, wherein
the mapping order of CSI part2 of the at least two sub-configurations is determined based on an order of the identifiers of the at least two sub-configurations.

10. The method according to claim 1, wherein when the CSI of the sub-configuration comprises at least two pieces of CSI, a mapping order of even subband CSI of CSI part2 of the at least two pieces of CSI is before a mapping order of odd subband CSI of CSI part2 of the at least two pieces of CSI, wherein
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol; and/or,
wherein
when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

11. A channel state information transmission method, comprising:
sending, by a network side device, a channel state information (CSI) report configuration; and
receiving, by the network side device, a CSI report, wherein
resources associated with the CSI report configuration are configured as N resource groups, the CSI report configuration is associated with at least one sub-configuration, and the CSI report comprises CSI of the at least one sub-configuration; or the network side device prohibits configuring the CSI report configuration to be associated with at least one sub-configuration when resources associated with the CSI report configuration are configured as N resource groups; or the network side device prohibits configuring resources associated with the CSI report configuration as N resource groups when the CSI report configuration is associated with at least one sub-configuration; and N is an integer greater than or equal to 2.

12. The method according to claim 11, wherein the sub-configuration comprises at least one of the following:
a first identifier, indicating a resource group associated with the sub-configuration;
a second identifier, indicating a transmission reception point (TRP) associated with the sub-configuration;
a port subset indicator;
a code book subset restriction (CBSR);
a rank indicator (RI) restriction;
at least one group of channel state information reference signal (CSI-RS) resources;
a power offset value;
channel measurement resource (CMR) pair configuration information;
a CSI report mode; or
a number of pieces of single TRP CSI reported when the CSI report mode is a first mode.

13. The method according to claim 12, wherein the first identifier comprises a bitmap for indicating the resource group associated with the sub-configuration;
or
the first identifier comprises a resource group identifier of the resource group associated with the sub-configuration.

14. The method according to claim 12, wherein the sub-configuration comprises N groups of CSI-RS resources, each group of CSI-RS resources comprises at least one CSI-RS resource of one of N resource groups associated with the CSI report configuration, and the N groups of CSI-RS resources correspond to the N resource groups respectively;
or
the sub-configuration comprises one group of CSI-RS resources, and a number of resources of the group of CSI-RS resources is the same as a number of the resources associated with the CSI report configuration;
or
the sub-configuration comprises one group of CSI-RS resources, and the group of CSI-RS resources comprises at least one resource of each of the N resource groups.

15. The method according to claim 12, wherein the CMR pair configuration information comprises CMR pairing information; or the CMR pair configuration information comprises an identifier of a CMR pair; or the CMR pair configuration information comprises a sequence number of a CMR pair in all CMR pairs configured in the CSI report configuration; and/or,
wherein
when the sub-configuration comprises the CMR pair configuration information, and the sub-configuration does not comprise the at least one group of CSI-RS resources, the CMR pair configured by the CMR pair configuration comprises resources from different resource groups in the resources associated with the CSI report configuration associated with the sub-configuration;
or
when the sub-configuration comprises the CMR pair configuration information, and the sub-configuration comprises the N groups of CSI-RS resources, the CMR pair configured by the CMR pair configuration comprises resources from two groups of CSI-RS resources in the N groups of CSI-RS resources;
or
when the sub-configuration comprises the CMR pair configuration information, and the sub-configuration comprises one group of CSI-RS resources, the CMR pair configured by the CMR pair configuration comprises resources from different resource groups in the one group of CSI-RS resources.

16. The method according to claim 11, wherein when the CSI report comprises CSI of at least two sub-configurations, the CSI of the at least two sub-configurations is mapped in ascending order of identifiers of the at least two sub-configurations;
wherein CSI part1 of the CSI report comprises at least two sub-configuration CSIs' CSI part1, and the at least two sub-configuration CSIs' CSI part1 is mapped in ascending order of the identifiers of the at least two sub-configurations.

17. The method according to claim 16, wherein a mapping order of wideband CSI of CSI part2 of the at least two sub-configurations is before a mapping order of subband CSI of CSI part2 of the at least two sub-configurations, and the wideband CSI of CSI part2 of the at least two sub-configurations is mapped in ascending order of the identifiers of the at least two sub-configurations; and
a mapping order of even subband CSI of CSI part2 of the at least two sub-configurations is before a mapping order of odd subband CSI of CSI part2 of the at least two sub-configurations, the even subband CSI of CSI part2 of the at least two sub-configurations is mapped in ascending order of the identifiers of the at least two sub-configurations, and the odd subband CSI of CSI part2 of the at least two sub-configurations is mapped in ascending order of the identifiers of the at least two sub-configurations.

18. The method according to claim 11, wherein when the CSI of the sub-configuration comprises at least two pieces of CSI, a mapping order of even subband CSI of CSI part2 of the at least two pieces of CSI is before a mapping order of odd subband CSI of CSI part2 of the at least two pieces of CSI, wherein
the even subband CSI of CSI part2 of the at least two pieces of CSI is mapped in a mapping order of multi-TRP CSI and single TRP CSI predefined in a protocol; and
the odd subband CSI of CSI part2 of the at least two pieces of CSI is mapped in a mapping order of multi-TRP CSI and single TRP CSI predefined in a protocol; and/or,
wherein
when a number of CSI-RS resources associated with the sub-configuration is 1, a maximum number of ports supported by each resource associated with the sub-configuration is 32;
or
when a number of CSI-RS resources associated with the sub-configuration is 2, a maximum number of ports supported by each resource associated with the sub-configuration is 16;
or
when a number of CSI-RS resources associated with the sub-configuration is greater than 2 and less than or equal to 8, a maximum number of ports supported by each resource associated with the sub-configuration is 8.

19. A terminal, comprising a processor and a memory, wherein the memory stores a program or an instruction that can be run on the processor, wherein the program or the instruction, when executed by the processor, causes the terminal to perform:
receiving a channel state information (CSI) report configuration; and
reporting a CSI report based on the CSI report configuration, wherein
resources associated with the CSI report configuration are configured as N resource groups, the CSI report configuration is associated with at least one sub-configuration, and the CSI report comprises CSI of the at least one sub-configuration; or the terminal does not expect that the CSI report configuration is associated with at least one sub-configuration when resources associated with the CSI report configuration are configured as N resource groups; or the terminal does not expect that resources associated with the CSI report configuration are configured as N resource groups when the CSI report configuration is associated with at least one sub-configuration; and N is an integer greater than or equal to 2.

20. A network side device, comprising a processor and a memory, wherein the memory stores a program or an instruction that can be run on the processor, and the program or the instruction is executed by the processor to implement the steps of the channel state information transmission method according to claim 11.
